(19) United States
(12) Patent Application Publication
(10) Pub. No.: US 2026/0229994 A1
(43) Pub. Date: Aug. 6, 2026

(54) MULTI-LAYER SOFTWARE-DEFINED SYSTEM AND METHOD FOR HIGH PERFORMANCE ENERGY CONVERSION

(71) Applicant: The Trustees of Columbia University in the City of New York, New York, NY (US)

(72) Inventors: Matthias Preindl, New York, NY (US); Liwei Zhou, New York, NY (US)

(21) Appl. No.: 19/152,390

(22) PCT Filed: Feb. 2, 2024
(86) PCT No.: PCT/US2024/014242

§ 371 Date: Jul. 30, 2025

Related U.S. Application Data
(60) Provisional application No. 63/443,178, filed on Feb. 3, 2023.

(51) Int. Cl. H02M 3/157; G05B 13/04; H02M 1/00; H02M 1/14; H02M 1/44; H02M 3/158

(52) U.S. Cl. CPC H02M 3/157; G05B 13/048; H02M 1/0058; H02M 1/0067; H02M 1/14; H02M 1/44; H02M 3/158

(57) ABSTRACT

A multi-layer software-defined power converter system and method is provided. The power converter system includes: a plurality of elementary power converter modules and at least one electronic processor. Each elementary power converter module includes, respectively, power switching elements and an LC filter. The at least one electronic processor is configured to: determine operational data for the power converter system; configure, based on the operational data, a power conversion function of the plurality of elementary power converter modules that defines active elementary power converter modules; determine electrical operating characteristics for the active elementary power converter modules; generate a control reference targets for the active elementary power converter modules based on the electrical operating characteristics; and control the power switching elements based on the electrical operating characteristic and the control reference target for the active elementary power converter module.

### CROSS-REFERENCE TO RELATED APPLICATIONS

The present application is based on and claims priority to U.S. Patent Application No. 63/443,178, filed on Feb. 3, 2023, the entire disclosure of which is hereby incorporated by reference.

### STATEMENT REGARDING FEDERALLY SPONSORED RESEARCH

This invention was made with government support under 1653574 awarded by the National Science Foundation. The government has certain rights in the invention.

### BACKGROUND

Power converters of various types have been produced and used in many industries and contexts. Example power converters include alternating current (AC) to direct current (DC) rectifiers, DC to AC inverters, and DC to DC converters. AC to DC rectifiers, also referred to as AC/DC rectifiers, converter AC power to DC power. DC to AC inverters, also referred to as DC/AC inverters, convert DC power to AC power. Power converters can be used for various purposes, such as, for example, rectifying AC power from an AC grid power source to DC power for charging a battery, or inverting DC power from a battery to AC power to drive a motor or supply AC power to an AC grid. Further, power converters can be used in various contexts, such as, for example, in or connected to an electric vehicle, an engine generator, solar panels, and the like.

### SUMMARY

Power converters may be described in terms of power conversion efficiency, power density, and cost, among other characteristics. Generally, it is desirable to have power converters with higher power efficiency, higher power density, and lower cost. A highly efficient power converter is able to convert power (e.g., AC to DC, DC to AC, and/or DC to DC) without significant losses in energy. A low efficiency power converter experiences higher losses in energy during the power conversion. Such energy losses may manifest as heat generated by the power converter while converting power, for example. Power efficiency for a power converter, inductor, or other electronic component may be expressed as a percentage between 0 and 100% and determined based on the power input to the component and the power output the component using the from equation:

$$Power Efficiency = \frac{Power Out}{Power In} .$$

A power converter with high power density has a high ratio of power output by the power converter compared to the physical space occupied by the power converter. The power density can be calculated using the equation:

$$Power Density = \frac{Power Out}{Volume of Power Converter} .$$

Energy costs, including monetary costs and environmental costs, continue to be an important factor across many industries that incorporate power converters. Accordingly, even slight increases (e.g., of tenths of a percent) in power efficiency for a power converter can be significant and highly desirable. Similarly, reductions in materials and size of power converters can be significant and highly desirable, allowing reductions in costs and physical space to accommodate power converters in systems that incorporate power converters.

In grid-connected power converter applications, such as, for example, electric vehicle (EV) chargers and photovoltaic (PV) power supplies, leakage current and DC bus utilization are factors that influence the performance. For the leakage current issue, a bulky line frequency transformer is typically installed to block the leakage path at the point of common coupling (PCC) which increases the cost, volume, and weight of the system. For the DC bus utilization, the DC bus voltage needs to be stepped up to be at least twice of the grid voltage amplitude to avoid saturation issue, which brings extra switching losses and challenges to the switch voltage tolerance capability.

Bidirectional power converters may be used to both charge a DC source using AC power and drive AC motors using DC power from the DC source. Such power converters, when included in an electric vehicle, may also be referred to as an integrated charger. An integrated charger may both be used as a primary charging interface for a battery of the electric vehicle, and also as the traction inverter to drive a motor of the electric vehicle. By using a dual-purpose power converter, rather than separate charger converter and traction inverter, material costs and size may be reduced. However, relative to dedicated power converters, dual-purpose power converters add complexities in designing an efficient and effective converter for both charging and traction modes. Further, the design factors extend beyond efficiency concerns because, without proper design, power converters can reduce motor lifetime due to leakage currents and/or common mode voltages causing current spikes in one or more of the motor bearings, motor shaft, motor windings, and gear train that can damage and reduce the lifetime of these components, respectively.

Some embodiments disclosed herein address these or other issues. For example, in some embodiments, a multi-layer software-defined architecture is provided based on a type of elementary power module to improve the energy conversion performance of an electric vehicle (EV) system. The architecture is composed of three layers: (1) application function layer for the interfaces with various types of electrified loads/sources and the corresponding control functions, such as, for example, single/three-phase grid, battery, motor, resistor; (2) elementary module layer for providing a desired number of basic power module(s) with local functions of variable frequency soft switching (VFSS) and, in some embodiments, include model predictive control (MPC) to increase the efficiency of power conversion with better transient performance; (3) interconnection management layer for the coordination and interconnection between the application function layer and elementary module layer to construct the complete power converter topology with the desired number of elementary power module(s) for the satisfaction of the interfaced load/source. The merits of the designed architecture include, for example: reconfigurability to be suitable for different types of power converter applications, common mode noise attenuation capability (e.g., for non-isolated topologies), improved efficiency and dynamic performance by VFSS and MPC of the elementary power module(s), high accuracy and robustness of the multi-layer control without being influenced by parametric modeling error from various applications, and the integration and reconfiguration of different components in a given system (e.g., power converters in EV applications).

For example, some embodiments disclosed herein are directed to power converters or power conversion methods including the three-layer software-defined architecture and using one or more of (i) zero sequence voltage control, (ii) active damping to mitigate resonance (in some embodiments, including model predictive control (MPC)), (iii) variable frequency critical soft switching (VFCSS). These features may be included in embodiments of a power converter independently or in any combination. For example, a power converter may include one of the above-noted features, any two of the above-noted features, or all three of the above-noted features. Additionally, in combination with any of these embodiments, the power converter may include at least one LC filter for each elementary module or for each phase of the power converter, where a capacitor of each LC filter is connected to a DC bus positive or negative terminal of the power converter and, in some cases, a further a capacitor of each LC filter is connected to the other of the DC bus positive or negative terminal of the power converter. The capacitors of each phase having a common point connected to the DC bus positive or negative terminals that create a bypassing path for zero sequence voltage control. The capacitor coupled to the DC bus positive terminal (an upper capacitor) may also reduce both EMI and the total ripple current handling requirements of the power converter without increasing the total capacitance or volume. In some embodiments disclosed herein, an additional drain-source capacitor (C_{DS}) is coupled across the drain and source terminals of the power switching elements, which can slow a voltage rise during an ON-to-OFF transition. This slowed voltage rise can, in turn, reduce the switching losses of the power switching elements.

A high performance controller such as, for example, a zero-sequence voltage MPC controller stabilizes the zero-sequence capacitor voltage to be, in some embodiments, a constant of approximately half DC bus voltage. Thus, the leakage current flowing through the grid or other coupled elements is attenuated. When included, explicit MPC at each elementary module reduces the execution complexity on a controller (e.g., a digital signal processor (DSP)) and does not need to update the angular speed in the state space matrix, which allows for the MPC optimization offline. Compared with a traditional proportional integral (PI) controller, embodiments of the MPC controller disclosed herein provides power converter control with improved dynamic performance and control bandwidth with faster response. In some embodiments, an MPC controller may be deployed across a set of modules.

The effective zero-sequence voltage control (through the LC filters and control schemes disclosed herein) also serves to reduce certain bearing currents, shaft currents, motor winding currents, gear train currents, and other currents that can potentially damage and reduce the life of motors and their components (bearings, shafts, wiring, etc.). For example, currents caused by high rates of change of voltage (dV/dt), especially at higher voltages (e.g., above 400 V, above or approaching 800 V, and levels between) can cause damage to motor bearings, motor shafts, motor windings (e.g., insulation may be damaged), and gear trains (e.g., bearing currents can propagate into the gear train via electromagnetic interference (EMI) or noise, vibration, harshness (NVH) resulting from the damaged bearing race walls).

In some examples, the power converter is driven using a variable frequency critical soft switching (VFCSS) scheme. The VFCSS scheme can provide improved efficiency and reduced filter volume (i.e., improved power density) for the power converter, where the VFCSS may be controlled as a discrete or continuous signal to drive a desired response.

In one embodiment, a multi-layer power converter system is provided. The power converter system includes: a plurality of elementary power converter modules and at least one electronic processor. Each elementary power converter module includes, respectively, power switching elements and an LC filter. The at least one electronic processor is configured to: determine operational data for the power converter system; configure, based on the operational data, a power conversion function of the plurality of elementary power converter modules, the power conversion function defining one or more of the elementary power converter modules as active elementary power converter modules for implementing the power conversion function; determine electrical operating characteristics including an electrical operating characteristic for each of the one or more active elementary power converter modules; generate a control reference target, respectively, for each of the one or more active elementary power converter modules, each control reference target generated based on the electrical operating characteristics; and control the power switching elements, of each of the one or more active elementary power converter modules, based on the electrical operating characteristic and the control reference target for the active elementary power converter module.

In one embodiment, a method for converting power is provided. The method includes: determining, by at least one electronic processor, operational data for a power converter system including a plurality of elementary power converter modules, each elementary power converter module including, respectively, power switching elements and an LC filter; configuring, by the at least one electronic processor based on the operational data, a power conversion function of the plurality of elementary power converter modules, the power conversion function defining one or more of the elementary power converter modules as active elementary power converter modules for implementing the power conversion function; determining, by the at least one electronic processor, electrical operating characteristics including an electrical operating characteristic for each of the one or more active elementary power converter modules; generating, by the at least one electronic processor, a control reference target, respectively, for each of the one or more active elementary power converter modules, each control reference target generated based on the electrical operating characteristics; and controlling, by the at least one electronic processor, the power switching elements, of each of the one or more active elementary power converter modules, based on the electrical operating characteristic and the control reference target for the active elementary power converter module.

In one embodiment, a non-transitory computer-readable medium storing computer-executable instructions is provided. The instructions cause at least one electronic processor to: determine operational data for a power converter system including a plurality of elementary power converter modules, each elementary power converter module including, respectively, power switching elements and an LC filter; configure, based on the operational data, a power conversion function of the plurality of elementary power converter modules, the power conversion function defining one or more of the elementary power converter modules as active elementary power converter modules for implementing the power conversion function; determine electrical operating characteristics including an electrical operating characteristic for each of the one or more active elementary power converter modules; generate a control reference target, respectively, for each of the one or more active elementary power converter modules, each control reference target generated based on the electrical operating characteristics; and control the power switching elements, of each of the one or more active elementary power converter modules, based on the electrical operating characteristic and the control reference target for the active elementary power converter module.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

FIG. 1 illustrates a power converter system according to some embodiments.

FIG. 2A illustrates a multi-layer software-defined power converter system according to some embodiments.

FIG. 2B illustrates a half-bridge power converter according to some embodiments.

FIG. 2C illustrates an isolated converter circuit according to some embodiments.

FIG. 3 illustrates a process for converting power using a multi-level software-defined power converter, according to some embodiments.

FIG. 4 illustrates a model predictive controller (MPC) variable frequency soft switching (VFSS) converter module according to some embodiments.

FIGS. 5A-B illustrates an example of the converter system of FIG. 2A in a single-phase grid electric vehicle (EV) charging mode configuration according to some embodiments.

FIG. 6 illustrates an equivalent parasitic circuit model for some configurations of the control system of FIG. 2A.

FIG. 7 illustrates an example of the converter system of FIG. 2A in a three-phase grid EV charging mode configuration according to some embodiments.

FIG. 8 illustrates an example of the converter system of FIG. 2A in a three-phase motor traction inverter configuration according to some embodiments.

FIG. 9 illustrates a phase phase-lock loop (PLL) functional block diagram to generate a phase (theta*) estimate for some configurations of the converter system of FIG. 2A, according to some embodiments.

FIGS. 10A-10B illustrate example waveforms from testing results for single- and three-phase EV charging configurations, according to some embodiments.

FIGS. 11A-11B illustrate example waveforms from testing results for a motor traction inverter configuration, according to some embodiments.

FIGS. 12A-12B illustrate example waveforms from testing results for single- and three-phase EV charging configurations, according to some embodiments.

FIGS. 13A-13B illustrate example waveforms from testing results for an EV charging configuration compared with conventional proportional integral (PI) control, according to some embodiments.

FIGS. 14A-14D illustrate example common mode voltage and leakage current waveforms from testing results for grid-connected EV charging configurations with and without zero-sequency control, according to some embodiments.

FIGS. 15A-15B illustrate example common mode voltage, shaft voltage, and leakage current waveforms from testing results for a traction motor configuration compared with a conventional traction motor control, according to some embodiments.

FIGS. 16A-16B illustrate example waveforms from testing results for an EV charging configuration using variable frequency soft switching (VFSS) and model predictive control (MPC), according to some embodiments.

FIGS. 17A-17B illustrate example waveforms from testing results for an EV charging configuration using variable frequency soft switching (VFSS) and model predictive control (MPC) and with a current step, according to some embodiments.

FIGS. 18A-18B illustrate efficiency curves of EV charging configurations and of a motor traction configuration, according to some embodiments.

FIGS. 19A-19B illustrate output current and total grid current before and after a module failure with two and three elementary converter modules in parallel, according to some embodiments.

FIGS. 20A-20B illustrate three-phase grid current, phase leg inductor current, and grid voltage before and after a module failure with two and three elementary converter modules in parallel, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “comprising,” “including,” “containing,” “having,” and variations thereof herein is meant to encompass the items listed thereafter and equivalents thereof as well as additional items. Additionally, the terms “connected” and “coupled” are used broadly and encompass both direct and indirect connecting and coupling, and may refer to physical or electrical connections or couplings. Furthermore, the phase “and/or” used with two or more items is intended to cover the items individually and the items together. For example, “a and/or b” is intended to cover: a (and not b); b (and not a); and a and b.

Disclosed herein are systems and methods related to multi-layer software-defined power converters, also referred to as voltage converters, that can provide power and/or voltage conversion with increased power efficiency, increased power density, and/or reduced cost, among other advantages.

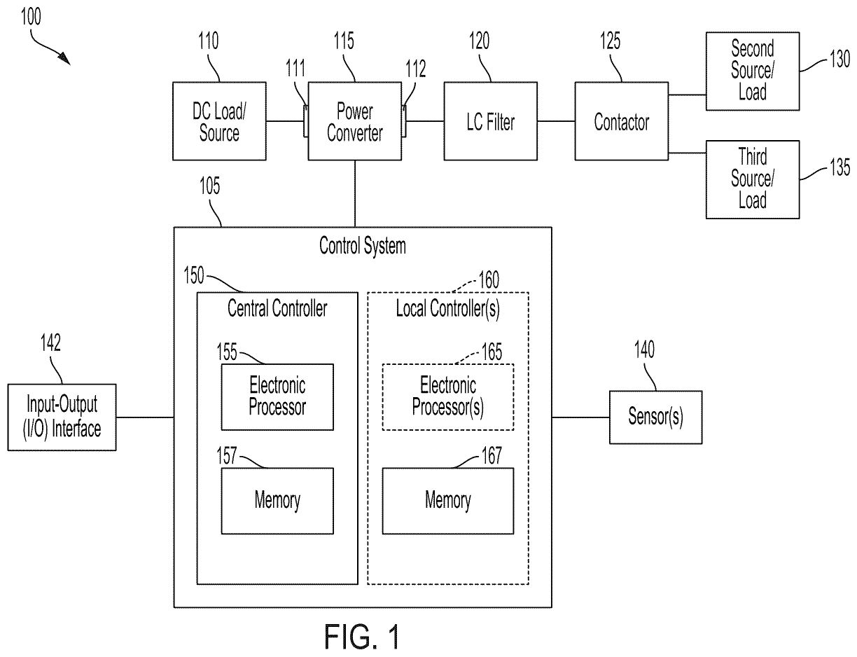

FIG. 1 illustrates a power converter system 100 in accordance with some embodiments. The power converter system 100 includes a control system 105, a first direct current (DC) load/source 110, a power converter 115 (also referred to as a power converter stage 115), an LC filter 120, a contactor 125, a second source/load 130, a third source/load 135, and one or more sensors 140. The control system 105 includes a central controller 150 with an electronic processor 155 and a memory 157, and, optionally, in some embodiments, includes one or more local controllers 160, each having an electronic processor 165 and a memory 167. The power converter system 100, as well as the other power converter systems provided herein, may be non-isolated power converter systems. That is, the power converter system may be coupled to an AC source (e.g., single or three phase power grid) or AC load (e.g., single or 3-phase motor) without a transformer. Use of a transformer is common in electrical circuits to provide isolation between the power converter and an AC source or load. However, such a transformer can add inefficiencies and size or volume to the power converter. Accordingly, power converter systems provided herein are non-isolated, also referred to as transformerless, to increase efficiency and/or reduce size of the power converter systems. Because such power converters are provided without isolation by a transformer, these power converters may include additional features to prevent transmission of unwanted signals or current (e.g., leakage current) from passing between the power converters and other circuit components (e.g., DC sources, DC loads, AC sources, AC loads, and other structures in contact with or supporting the power converters). In other examples, the power converter systems may include an isolation transformer.

In operation, generally, the control system 105 controls power switching elements of the power converter 115 with control signaling (e.g., pulse-width modulated (PWM) signals) to convert power (i) from the DC load/source 110 functioning as a source to the second source/load 130 or the third source/load 135 (depending on the state of the contactor 125) functioning as a load, or (ii) from the second source/load 130 or the third source/load 135 (depending on the state of the contactor 125) functioning as a source to the DC load/source 110 functioning as a load. Accordingly, when the DC load/source 110 is functioning as a source for the power converter 115, the second source/load 130 (or third source/load 135, depending on the state of the contactor 125) is functioning as a load for the power converter 115. Conversely, when the DC load/source 110 is functioning as a load for the power converter 115, the second source/load 130 (or third source/load 135, depending on the state of the contactor 125) is functioning as a source for the power converter 115.

The DC load/source 110 may be a direct power (DC) load, a DC source, or both a DC load and DC source (i.e., functioning as DC source in some instances and as a DC load in other instances, depending on the mode of the power converter 115). In some examples, the DC load/source 110 is a battery. In other examples, DC load/source 110 may be a capacitor, an ultracapacitor, a DC power supply from rectified AC source (e.g., AC grid power converted to DC power by diode bridge rectifier), or the like. The second source/load 130 may be an AC load, an AC source, both an AC load and AC source (i.e., functioning as an AC source in some instances and as an AC load in other instances, depending on the mode of the power converter 115), a DC load, a DC source, both a DC load and DC source (i.e., functioning as a DC source in some instances and as a DC load in other instances, depending on the mode of the power converter 115). In some examples, the second source/load 130 may be an electric (AC) motor, an AC generator, AC power supply grid, a DC battery, a DC capacitor, a DC ultracapacitor, a DC power supply from rectified AC source (e.g., AC grid power converted to DC power by diode bridge rectifier), or the like. The third source/load 135 may be an AC load, an AC source, both an AC load and AC source (i.e., functioning as an AC source in some instances and as an AC load in other instances, depending on the mode of the power converter 115), a DC load, a DC source, both a DC load and DC source (i.e., functioning as a DC source in some instances and as a DC load in other instances, depending on the mode of the power converter 115). In some examples, the third source/load 135 may be an electric (AC) motor, an AC generator, AC power supply grid, a DC battery, a DC capacitor, a DC ultracapacitor, a DC power supply from rectified AC source (e.g., AC grid power converted to DC power by diode bridge rectifier), or the like.

In some examples, the DC load/source 110 is a DC battery (e.g., an electric vehicle battery), the second source/load 130 is an AC grid, and the third source/load 135 is an AC motor (e.g., an electric vehicle motor). In this case, the power converter 115 may function as a bi-directional converter that operates in a DC/AC traction mode (or motor mode) to drive the third source/load 135 (motor) with AC power converted from DC power from the DC load/source 110 (battery), and an AC/DC charging mode to charge the DC load/source 110 (battery) with DC power converted from AC power from the second load/source 130 (AC grid). In some other examples, the DC load/source 110 is a DC source, the second source/load 130 is an AC motor, and no third source/load 135 is present in the system 100. In some other examples, the DC load/source 110 is a DC source, the second source/load 130 is an AC grid, and no third source/load 135 is present in the system 100.

The contactor 125 is an electrically controlled switch, and may include, for example, one or more contactors, relays, MOSFETs, or the like. In some examples of the system 100, the contactor 125 is not present and, instead, the LC filter 120 is connected to both the second source/load 130 and the third source/load 135 simultaneously. However, other control techniques are employed to prevent, for example, driving the third source/load 135 as a load (e.g., a motor), when receiving power from the second source/load 130 as a source (e.g., an AC grid).

The DC load/source 110 is coupled to the power converter 115 at a first (DC) side or section 111 of the power converter 115, and the second source/load 130 is coupled to the power converter 115 at a second (AC) side or section 112 of the power converter 115. The first side may also be referred to as an input side or an output side of the power converter 115, depending on the mode of the power converter, or as a DC side of the power converter 115. The second side may also be referred to as an input side or an output side of the power converter, depending on the mode of the power converter, or as an AC side of the power converter 115. In some embodiments, the second side of the power converter 115 may be an AC side having single phase AC power, three-phase AC power, or AC power with another number of phases.

In some embodiments, the power converter 115 operates with a high DC voltage level. For example, in operation, the DC side of the power converter 115 has a DC voltage (e.g., across input terminals of the power converter 115) of at least 200 V, at least 600 V, at least 800 V, at least 1000 V, at least 1200 V, between 200 V and 1200 V, between 600 V and 1200 V, between 800 V and 1200 V, or another range. Such high DC voltage levels may be desirable in some contexts, such as, for example, some electric vehicles. For example, some current electric vehicles (e.g., passenger vehicles and hybrid electric vehicles) operate with a DC bus voltage of between about 200 V and 400 V. This DC bus voltage for passenger electric vehicle may increase in the future. Further, some current electric vehicles (e.g., class 4-8, off-road, or otherwise larger electric vehicles) can operate with a DC bus voltage of more than 1000 V. However, high DC voltage levels may introduce challenges into a typical power converter system, such as, for example, an increase in leakage currents, increases in common mode voltage, higher rates of change in common mode voltage, and the like. These challenges can lead to resonance on the LC filter 120, shaft voltages, excessive bearing currents (e.g., from discharge events when lubricant dielectric breakdown occurs) that can result in bearing failures, excessive motor shaft currents, excessive motor winding currents (e.g., insulation may be damaged), and excessive gear train currents (e.g., bearing currents can propagate into the gear train via electromagnetic interference (EMI) or noise, vibration, harshness (NVH) resulting from the damaged bearing race walls). Embodiments described herein, however, can mitigate such challenges through improved LC filters and through control techniques including control techniques that use harmonic injection, cascaded controllers, MPC control, and/or variable frequency critical soft switching (VFCSS).

The LC filter 120, which may be referred to as an N-phase LC filter, includes an LC filter for each phase of the power converter 115. Each LC filter of the N-phase LC filter may include at least an inductor (L_{f}) and a capacitor (C_{f,up} or C_{f,down}), or at least an inductor (L_{f}) and two capacitors (C_{f,up} and C_{f,down}).

The sensor(s) 140 include, for example, one or more current sensors and/or one or more a voltage sensors. For example, the sensor(s) 140 may include a respective current sensor and/or voltage sensor to monitor a current and/or voltage of one or more of the DC load source 110, each phase of the second source/load 130, each phase of the third source/load 135, each phase of the LC filter 120, or other nodes or components of the power converter 115. For example, when the LC filter 120 is a three-phase LC filter, the sensors 140 may include at least three current sensors, one for sensing current at each phase of a three phase LC filter 120. In some embodiments, additional or fewer sensors 140 are included in the system 100. For example, the sensors 140 may also include one or more vibration sensors, temperature sensors, and the like. In some examples, the control system 105 infers a characteristic (e.g., current or voltage) of the power converter 115, rather than directly sensing the characteristic. The sensor(s) 140 may provide sensor data to the control system 105 indicative of the sensed characteristics of the system 100. Such sensor data may, accordingly, indicate electrical operational characteristics of the system 100. In some examples, the control system 105 infers or estimates a characteristic (e.g., current or voltage) at one or more nodes of the power converter 115 based on the sensor data of a sensor 140 that senses a different type of characteristic or even a different component, rather than directly sensing the characteristic. Further description of such inferencing or estimating are provided below with respect to state estimation.

The input-output (I/O) interface 142 includes or is configured to receive input from one or more inputs (e.g., one or more buttons, switches, touch screen, keyboard, and the like), and/or includes or is configured to provide output to one or more outputs (e.g., LEDs, display screen, speakers, tactile generator, and the like). Other electronic devices and/or users may communicate with the system 100 and, in particular, the control system 105, via the I/O interface 142. For example, the control system 105 may receive commands (e.g., from a user or another device) for the power converter system 100 indicating a target torque, target speed, target power level, conversion type, or the like. The control system 105, in response, may drive the power converter 115 to achieve the target and/or conversion type indicated by the command.

The control system 105 generally monitors the system 100 including the power converter 115 (e.g., based on sensor data from the sensor(s) 140), receives commands (e.g., via the input/output interface 142), and controls the power switching elements of the power converter 115 with control signaling (e.g., pulse-width modulated (PWM) signals) to convert power (e.g., in accordance with the sensor data and/or the commands). In some embodiments, the control system 105 includes a controller (e.g., the central controller 150) that performs this monitoring and control without additional local controllers. In other embodiments, the control system 105 is a cascaded control system including a central controller 150 and one or more local controllers 160. The cascaded control system may communicate in real time (e.g., each control cycle) monitoring information (e.g., sensor data) and control information between the central controller 150 and the one or more local controller 160. In some examples, the local controller(s) 160 each implement model predictive control (MPC) or another regulation control scheme (e.g., proportional integral derivative (PID) control, proportional integral (PI) control, or the like). In some examples, the central controller implements a non-MPC regulation technique, such as, for example, PID control or PI control. In some examples of the cascaded control system, each phase or each elementary module (described below) of the system 100 includes a respective local controller 160, and one of the local controllers 160 further performs the central control functionality (e.g., providing a reference target to the local control logic of each local controller 160 for regulation of its associated phase or elementary module). In other words, in such examples, a separate dedicated central controller 150 is not present but, rather, its control functionality is incorporated into one of the local controllers 160.

Each controller of the control system 105, including the central controller 150 and the local controller(s) 160, is an electronic controller that may include an electronic processor. Such an electronic controller may further include a memory (e.g., the memory 157 or 167). The memory is, for example, one or more of a read only memory (ROM), random access memory (RAM), or other non-transitory computer-readable media. The electronic processor 155, 165 is configured to, among other things, receive instructions and data from the memory 157, 167 and execute the instructions to, for example, carry out the functionality of the associated controller described herein, including the processes described herein. For example, the memory may include control software. In some embodiments, instead of or in addition to executing software from the memory to carry out the functionality of the controller described herein, the electronic processor includes one or more hardware circuit elements configured to perform some or all of this functionality. Each electronic processor 155, 165 may be or include, for example, one or more microprocessors, digital signal processors (DSPs), application specific integrated circuits (ASICs), field programmable gate array (FPGA), or a combination thereof. Additionally, although a particular controller, electronic processor, and memory may be referred to as a respective, single unit herein, in some embodiments, one or more of these components is a distributed component. For example, in some embodiments, an electronic processor includes one or more microprocessors and/or hardware circuit elements.

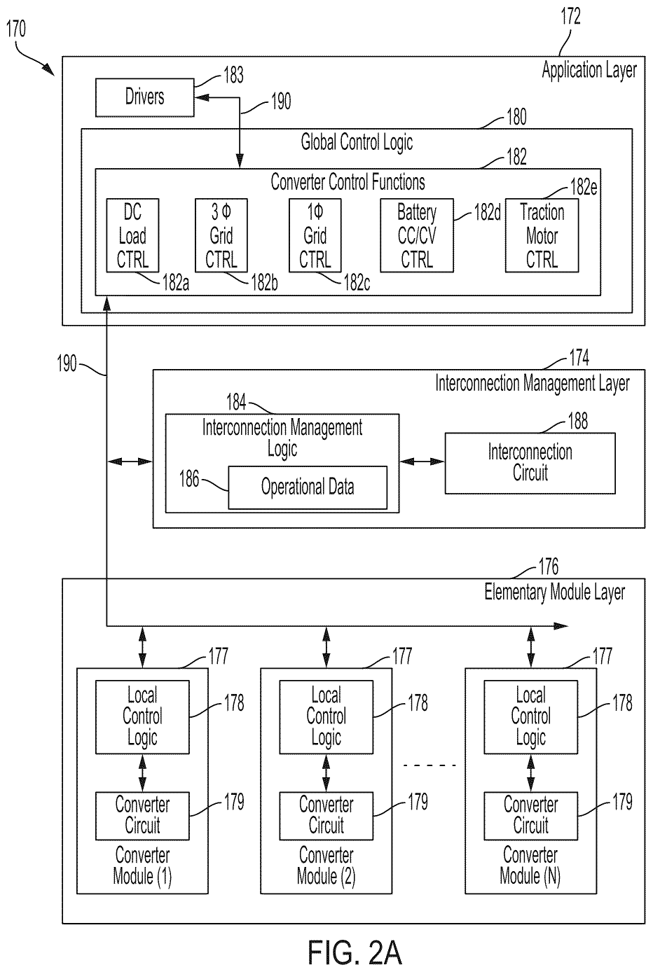

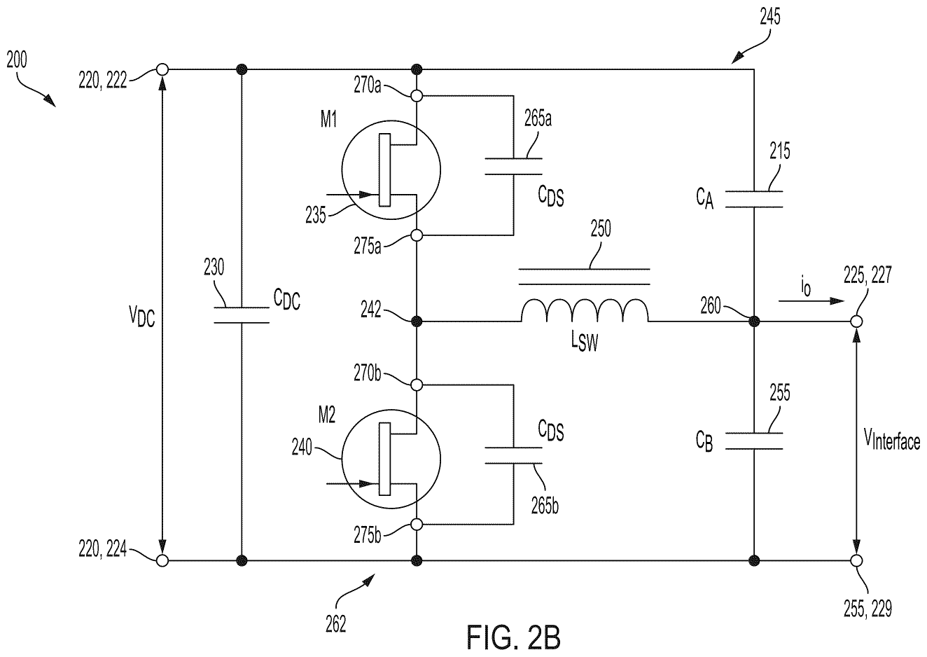

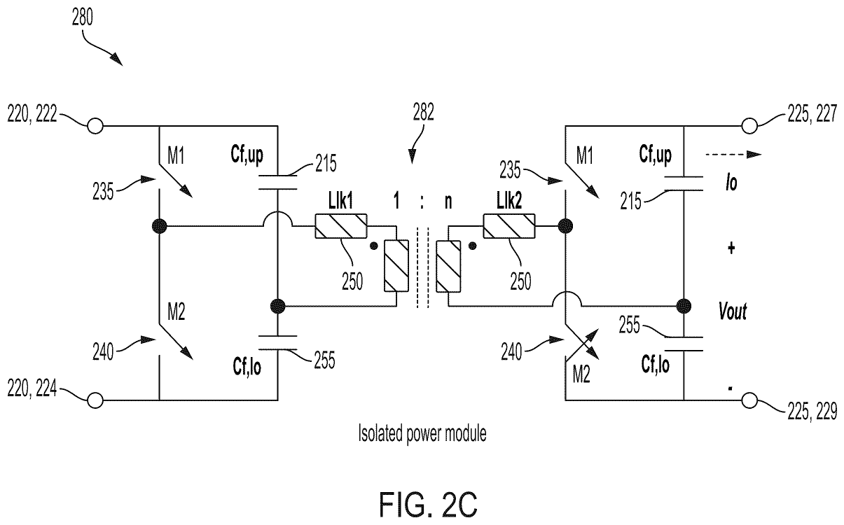

In some examples, the system 100 implements the aforementioned multi-layer software-defined power converter. For example, FIG. 2A illustrates a multi-layer software-defined power converter system 170. The converter system 170 is an example implementation of the system 100 of FIG. 1 that is organized according to a multi-layer architecture (described further below) and which enables configuration via software. Although the converter system 170 may be an implementation of the system 100, in some examples, the multi-layer software-defined power converter may not include one or more components of the system 100 illustrated in FIG. 1. For example, the converter system 170 may not itself include one or more of the loads/sources 110, 130, and/or 135, contactor 125, and/or I/O interface 142 but, rather, may be connected to these elements. In other examples, these elements may be considered part of the converter system 170.

The converter system 170 includes three layers: an application function layer 172, interconnection management layer 174, and elementary module layer 176. The elementary module layer 176 may include a plurality of elementary converter modules 177 (e.g., N elementary converter modules 177), also referred to as elementary power converter modules 177. Each elementary converter module 177 may include local control logic 178 and a converter circuit 179. For example, each elementary converter module 177 may include a combination of a half-bridge converter circuit of the power converter 115 and an LC filter circuit of the LC filter 120 as the converter circuit 179, and a portion of the control system 105 as the local control logic 178. With reference to FIGS. 1 and 2A, each instance of local control logic 178 may reside on a separate local controller 160, or a local controller 160 or central controller 150 may include local control logic 178 for multiple elementary converter modules 177. The local control logic 178 may implement, for example, MPC-variable frequency soft switching (VFSS) control, as described further below, to control the half-bridge converter circuit associated with the local control logic 178.

In some examples, the application function layer 172 includes global control logic 180 configured to generate a control reference target (e.g., v_{c}*, vₒ*, etc.)) for each local control logic 178 of the elementary module layer 176. The global control logic 180 may include a plurality of converter control functions 182, also referred to as power conversion functions 182. Of the plurality of converter control functions 182, one or more of which may be active (to generate the control reference targets) given the particular operation mode of the software-defined power converter. Similarly, depending on the particular operation mode, one or more of the plurality of converter control functions 182 may be inactive or idle. Further, in some examples, the converter control functions of the plurality of converter control functions 182 may be updated (e.g., by flashing new firmware or otherwise updating the functions stored in the system 170) to expand, reduce, and/or alter functionality of the converter system 170. For example, via a firmware update, the number and/or type of converter control functions 182 present in the converter system 170 may increase, decrease, or otherwise change. In some examples, the elementary converter modules 177 may be organized into one or more groups, with each group including one or more of the elementary converter modules 177 and being configured to provide or perform a particular power conversion (e.g., AC/DC, DC/AC, or DC/DC). Each group of one or more elementary converter modules configured to provide a particular power may be associated with a respective active converter control function of the converter control functions 182 of the global control logic 180. Each active converter control function of the global control logic 180 then generates the control reference targets for the group of elementary converter modules 177 associated with the active converter control function. Converter control functions 182 of the global control logic 180 that are not active may be considered inactive or idle.

FIG. 2A illustrates several example converter control functions 182, including DC load control function 182a, a three-phase grid control function 182b, single phase control function 182c, battery charging constant current/constant voltage (CC/CV) control function 182d, and motor speed/torque control function 182e. The converter control functions 182 may include additional types, such as, for example, a solar power converter control function, a wind power converter control function, a generator converter control function, or another type. In other examples, additional, fewer, or different combinations of converter control functions are provided in the converter control functions 182.

The global control logic 180 may be implemented on the central controller 150 as a separate, distinct controller, or may be implemented by one of the local controllers 160 (that also includes local control logic 178 for at least one elementary power module). In some examples, each local controller 160 may be capable of implementing the global control logic 180, with one selected at a time to actually implement the global control logic 180. In such examples, the system 170 includes redundancies such that, if a fault in the local controller 160 implementing the global control logic 180 occurs, another local controller 160 may be selected to implement the global control logic 180 (e.g., via a self-selecting priority scheme defined in and implemented by each of the local controllers 160).

The application function layer 172 may also include the loads and/or sources connected to the software-defined power converter system 170 (e.g., a DC load, 3-phase grid, single-phase grid, battery, e-motor), the connections or connectors to these loads and/or sources (see, e.g., contactor 125 of FIG. 1), or both. The connector or connectors may be selectively controllable (e.g., by the interconnection management layer 174) to make/break connections between (i) power converter 115 and LC filter 120 and (ii) the loads and/or sources.

The application function layer 172 may further include drivers 183. Each driver of the drivers 183 may be communicated by, and received from, a respective load and/or source, may be received from an external source, or may be pre-loaded at the time of manufacture. Each driver of the drivers 183 may define or indicate the converter control function(s) 182 associated with a particular load and/or source that the converter system 170 should employ when providing conversion functions for the particular load and/or source. For example, a battery (an example of a load and/or source) may communicate a driver of the drivers 183 that defines a charging control function (e.g., the battery constant current/constant voltage charging control function 182d) of the converter control functions 182 for use with the battery. Similarly, an electric motor (an example of a load and/or source) may communicate a driver of the drivers 183 that defines a traction motor control function (e.g., the traction motor control function 182e) of the converter control functions 182 for use with the motor. The drivers 183 may be stored in a memory of the converter system 170 (e.g., the memory 157 or 167 of FIG. 1).

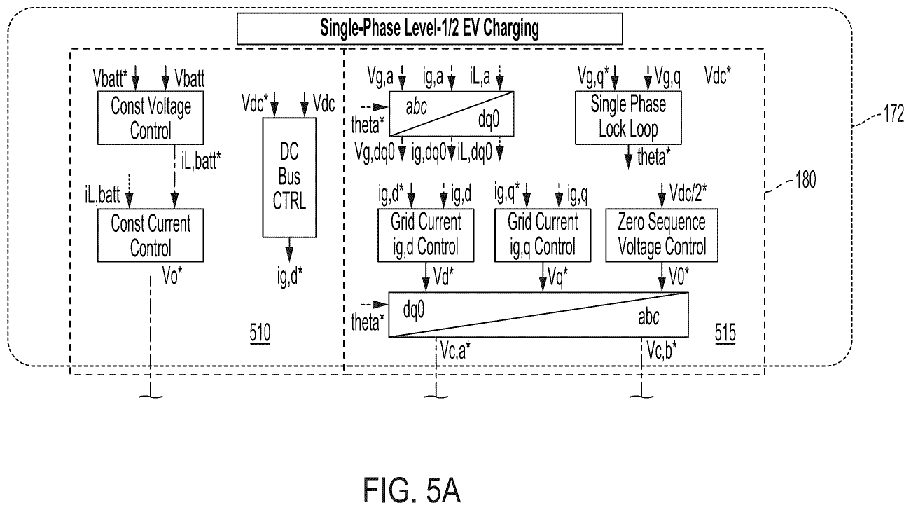

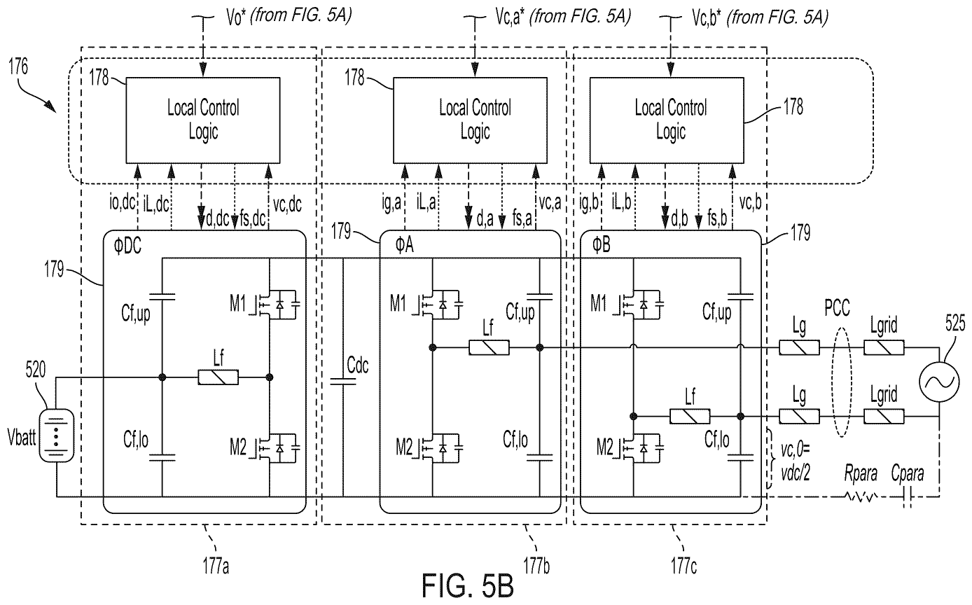

The interconnection management layer 174 may configure the software-defined power converter system 170 for operation. For example, the interconnection management layer 174 may include interconnection management logic 184 implemented by the control system 105 and, in particular, the central controller 150 or one of the local controllers 160. The interconnection management logic 184, and bus 190, may include and permit bidirectional, for example, to receive commands and/or data, and to transmit commands and/or data (e.g., feedback) to/from the application layer 172, the elementary layer 176, and/or other networked (external) modules (e.g., an electric vehicle or grid controller). The interconnection management logic 184 is configured to determine operational data 186 for the software-defined power converter system 170. The operational data 186 may be indicative of a power conversion application type of the power converter system 170, a number of conversion stages for the power converter system 170, a converter topology for each of the conversion stages, and a number of the plurality of elementary converter modules 177 for each of the converter topologies. The interconnection management logic 184 may then configure, based on the operational data 186, the converter control function(s) 182 of the plurality of elementary power converter modules 177. For example, the interconnection management logic 184 may indicate to the global control logic 180 which of the converter control functions 182 to activate, which elementary converter modules 177 are associated with each converter control function 182 that was activated (e.g., by communicating particular identifiers unique to each respective elementary converter module 177), and/or which of the converter control functions 182 and/or elementary converter modules 177 are to be idle or remain idle. Additionally, for a particular operation mode of the software-defined power converter system 170, the interconnection management logic 184 may control switches to alter and configure the interconnections between elementary converter modules 177 to achieve the desired power conversion. For example, switches of the interconnection circuit 188 may be located between connecting nodes of the various elementary converter modules 177 to enable different configurations or connections thereof, such as, for example, the different configurations shown, respectively, in FIGS. 5A-B, 7, and 8. In other examples, the interconnections between the elementary converter modules 177 may remain unchanged despite different converter control functions 182 and/or groupings of the elementary converter modules 177. In such examples, the global control logic 180 can change the operation mode of the power converter 170 by changing the active control functions of the converter control functions 182 and providing corresponding reference targets to the elementary converter modules 177 based on whichever converter control functions 182 are active. Further, the global control logic 180 may render an elementary converter module 177 inactive or idle by, for example, controlling power switching elements thereof to simply remain “off” or in an open (non-conducting) state.

Each of the application function layer 172, interconnection management layer 174, and elementary module layer 176 (and, thus, each controller of the control system 105) may be connected by a real-time bus 190 to enable real-time communications (e.g., communications that may occur each control cycle). For example, the real-time bus may include one or more of a controller area network (CAN) bus, Ethernet/IP bus, fiber optic bus, fast serial interface (FSI) bus, and/or coaxial bus. Accordingly, the communications between layers (or components thereof) described herein may occur via this real-time bus 190. The components communicating via the real-time bus 190 (e.g., each controller of the control system 105) may have a transceiver (e.g., a CAN transceiver, FSI transceiver, Ethernet transceiver, etc.) to enable the communications. In some examples, the real-time bus 190 is a portion of the I/O interface 145 (see FIG. 1) and enables the components of the system 170 (e.g., the application function layer 172, the interconnection management layer 174, and/or the elementary module layer 176) to communicate with devices or systems external to the system 170 (e.g., an electric vehicle (EV) controller, a grid controller, etc.). In some examples, one or more further communication lines or buses are provided to enable communications between components. For example, the local control logic 178 of a particular elementary converter module 177 may communicate via dedicated lines with the converter circuit 179 of the particular elementary converter module 177. In still further examples, one or more dedicated lines may be provided in place of a portion or all of the real-time bus 190 to enable communication among the layers 172, 174, and 176.

Operational data 186, as determined by the interconnection management logic 184, may include application types and requirements for the software-defined converter system 170, types of loads and sources interfaced with the software-defined converter system 170, a number of power stages per application of the software-defined power converter system 170, a converter topology for each of the power stages, and a number of (and/or identification of) the elementary converter modules 177 for each converter topology. A particular combination of these parameters (e.g., application type, requirements, loads and sources, number of power stages, converter topology for each power stage, and number/identity of elementary converter modules 177) may be referred to as an operational mode of the power converter system 170. The operational data 186 may define multiple operational modes available for selection and implementation by the power converter system 170.

In some examples, the operational data 186 may have a portion that is generally for the converter system 170 (e.g., the available operational modes). For example, the interconnection management logic 184 may recognize its application types and requirements and the types of loads and sources based on prestored data in a memory of the control system 105, which may be programmed into the interconnection management logic 184 (e.g., stored in a memory) as the operational data 186 at the time of manufacture or assembly. As an example, the interconnection management logic 184 may recognize that the converter system 170 is coupled to a three-phase traction motor (indicating that the system should act as a three-phase inverter in some instances) and is coupled to a battery and a three-phase power input (indicating that the system should act as a three-phase AC to DC converter in some instances). As another example, the interconnection management logic 184 may define the number of power stages for the converter system 170. For example, the interconnection management logic 184 may determine that the system 170 should be configured to implement two power stages (e.g., AC/DC and DC/DC, or DC/DC and DC/AC) or one power stage (e.g., DC/DC), or another number of power stages. In some examples, the interconnection management logic 184 further determines and defines a particular topology to implement for each power converter stage. For example, the interconnection management logic 184 may determine to configure a DC/DC converter stage as a step-up converter, a step-down converter, or both a step-up and step-down converter, may configure an AC/DC stage as single phase or three phase, may configure converters to be in parallel or multi-level cascade, may configure one or more converters to operate as non-isolated converters (e.g., where each elementary converter module 177 that is included in the converter(s) may be transformerless), or may configure one or more converters to operate as isolated converters (e.g., where a transformer is included as part of an elementary converter module 177 that is included in the converter(s)). In some examples, the interconnection management logic 184 may further determine and define the number of elementary converter modules 177 per converter topology. For example, the interconnection management logic 184 may define that a three-phase AC/DC converter be implemented with one, two, or three elementary converter modules 177 in parallel. A higher number of elementary converter modules 177 may be configured to operate in parallel to meet higher power demands, while fewer elementary converter modules 177 (or none) may be configured to operate in parallel to meet lower power demands.

At least a portion of the operational data 186 may be dynamic to account for changing factors or circumstances of the system 170, and to trigger dynamic reconfiguration of the system 170 to change operation modes. For example, the operational data 186 may include a mode parameter that is dynamic or changing depending on the circumstances. The mode parameter may indicate the current mode in which the converter system 170 should operate, and the value of the mode parameter (e.g., the current mode) may be selected from the available operation modes of the converter system 170. As noted above, each available operational mode may be defined by an application type and requirements for the software-defined power converter system 170 in the mode, an indication of the type of loads and sources interfaced with the software-defined power converter system 170 in the mode, the number of power stages per converter system of the software-defined power converter system 170 in the mode, the converter topology for each of the power stages in the mode, and the number of (and/or identification of) the elementary converter modules 177 for each converter topology in the mode. These parameters defining the operational mode may be referred to as mode configuration data. Example values for the mode parameter (i.e., example modes) of the converter system 170 include single-phase grid-connected battery charging, three-phase grid-connected battery charging, single phase grid supply, three phase grid supply, DC load control, traction motor control, wind power conversion, solar power conversion, and the like. The mode configuration data for each mode may also include or be associated with one or more of the converter control functions 182 that will be used by the converter system 170 to implement the operation mode.

The operational data 186 may be defined differently for different instances of converter systems 170 that otherwise have a similar or the same hardware configuration. For example, the operational data 186 for a first instance of the converter system 170 may define a different combination of operational modes than the operational data 186 for a second instance of the converter system 170. Thus, through software configuration or definition using the operational data 186 (and converter control functions 182), the same power converter hardware platform of the converter system 170 may be used in different settings and configurations, thereby providing custom solutions without custom hardware, reducing manufacturing and design costs that would otherwise be incurred to provide such custom solutions. Additionally, the operational data 186 of the converter system 170 may not be static and, rather, may be updated in the field to account for changing environment or circumstances.

Each of the local control logic 178, global control logic 180, and interconnection management logic 184 may be implemented in hardware, software, or a combination thereof. For example, local control logic may be implemented by a dedicated application specific integrated circuit (ASIC) digital signal processor that performs the described functionality, may be a set of instructions that, when executed by a processor, causes the processor to perform the described functionality, may be implemented by a field programmable gate array (FPGA), or a combination thereof.

FIG. 2B illustrates an example of a converter circuit, or converter, 200 that may serve as the converter circuit 179 of each elementary converter module 177 in the elementary module layer 176 of FIG. 2A. The converter circuit 200 may include a half-bridge power converter and an LC filter. As illustrated, the converter 200 includes DC terminals 220 (also referred to as DC nodes, DC links, DC rails, etc.) having a positive DC terminal 222 and a negative DC terminal 224. The converter 200 further includes interface terminals 225 (also referred to as interface nodes) having a positive interface terminal 227 and negative interface terminal 229. The converter 200 may be operated as a bidirectional converter or as a unidirectional converter (in either direction), depending on the configuration and control of the system in which it is implemented. Accordingly, the DC terminals 220 may be input terminals and the interface terminals 225 may be output terminals in some examples (e.g., DC/DC conversion and DC/AC inversion), and the DC terminals 220 may be output terminals and the interface terminals 225 may be input terminals in some examples (e.g., AC/DC rectification). Additionally, the interface terminals 225 may be AC input terminals (e.g., for AC/DC rectification), may be AC output terminals (e.g., for a DC/AC inverter), or may be DC output terminals (e.g., for DC/DC conversion).

The converter 200 further includes a DC link capacitor (CDC) 230, a high side (upper) power switching element (M1) 235 (also referred to as upper switch or upper FET 235), a low side (lower) power switching element (M2) 240 (also referred to as lower switch or lower FET 240), a midpoint node 242 connecting a drain terminal of upper switch 235 and a source terminal of lower switch 240, and an LC filter 245. The LC filter 245 is an example of the LC filter 120 of the system 100 of FIG. 1 (e.g., where the LC filter 120 is an N-phase LC filter with N=1). The LC filter 245 may also be a portion of the LC filter 120 of FIG. 1, for example, when the power converter 115 of FIG. 1 includes multiple half bridge converters and the LC filter 120 includes multiple LC filters (e.g., one LC filter per converter).

The switches 235 and 240 may be field effect transistors (FETs), each having a respective gate, source, and drain terminal. The FETs may be, for example, a MOSFET, a silicon carbide (SiC) FET, a gallium nitride (GaN) FET, among other types of FETs.

The LC filter 245 includes a switch-side inductor L_{SW} 250, a lower capacitor CB 255, and an upper capacitor CA 215. The switch-side inductor L_{SW} 250 is coupled between the midpoint node 242 and a filter node 260. For example, a first end of the switch-side inductor L_{SW} 250 is coupled to the midpoint node 242, and a second end is coupled to the filter node 260. The lower capacitor CB 255 is coupled between the filter node 206 and the negative DC terminal 224. For example, a first end of the lower capacitor CB 255 is coupled to the filter node 260, and a second end is coupled to the negative DC terminal 224. The upper capacitor CA 215 is coupled between the filter node 260 and the positive DC terminal 222. For example, a first end of the lower capacitor CA 215 is coupled to the filter node 260, and a second end is coupled to the positive DC terminal 222.

In some examples, the LC filter 245 is an LCL filter (an LC filter with an additional inductor (L)), in which an additional (interface) inductor is coupled between the filter node 260 and the positive interface terminal 227.

The upper capacitor 215 allows for the ripple currents at both input nodes and output nodes (nodes 222, 227) of the converter 200 to be shared. Because the ripple currents on the input nodes and the ripple currents on the output nodes have some correlation, differential mode currents of these input and output nodes can be canceled through this capacitance. This reduction in differential mode current can result in improved EMI performance and decreased total capacitor ripple current when compared with a typical half-bridge converter (e.g., when the total capacitance between the two converters is held constant). Furthermore, the reduction in total capacitor ripple current can allow for a decrease in capacitor size, for example, when capacitor ripple current drives capacitor sizing.

The converter further includes drain-source capacitors C_{DS} 265a and 265b, each respectively coupled across one of the switches 235, 240. In particular, a first drain-source capacitor 265a is provided across a source terminal 270a and drain terminal 275a of the upper switch (M1) 235, and a second drain-source capacitor 265b is provided across a source terminal 270b and drain terminal 275b of the lower switch (M2) 240. The drain-source capacitors (C_{DS}) 265a-b may be generically and collectively referred to herein as drain-source capacitor(s) (C_{DS}) 265.

The drain-source capacitors (C_{DS}) 265 can slow a voltage rise during an ON-to-OFF transition of the switches 235 and 240. This slowed voltage rise can, in turn, reduce the switching losses of the switches 235 and 240.

In some examples of the converter 200, one or both of the upper capacitor CA 215 and the drain-source capacitors C_{DS} are not included in the converter 200.

FIG. 2C illustrates an example of an isolated converter circuit, or isolated converter, 280 that may serve as the converter circuit 179 of one or more of the elementary converter modules 177 in the elementary module layer 176 of FIG. 2A. The isolated converter 280 may include a switch bridge, an LC filter, and, in contrast to the (non-isolated) converter circuit 200, a transformer 282. The switch bridge of the isolated converter 280 may include switches 235, 240 on each side of the transformer 282, and the LC filter may include inductors 250 and capacitors 215, 255 on each side of the transformer 282 as well. The majority of the description herein refers to use of the converter 200 in the converter system 170; however, the isolated converter 280 may generally be used in place of the converter circuit 200 in embodiments provided herein, unless otherwise noted.

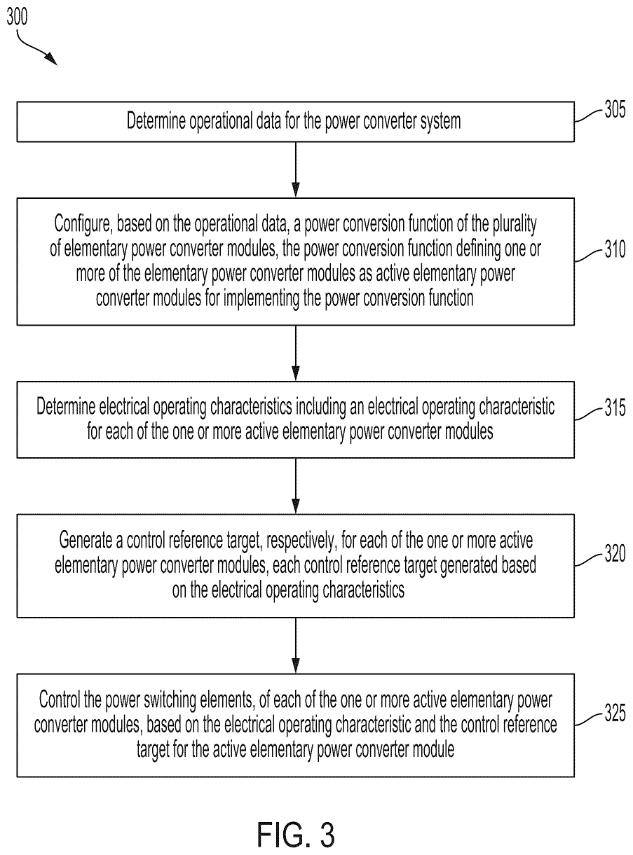

FIG. 3 illustrates a process 300 for power conversion using a multi-level software-defined power converter. The process of FIG. 3 may be carried out by the power converter system 100 or, more particularly, by a control system 105 of the power converter system 100. For example, to implement the process 300, the power converter system 100 may be configured as a multi-layer software-defined power converter 170 as illustrated in FIG. 2A. However, in some embodiments, the process of FIG. 3 may be implemented by another power converter system. Additionally, although the blocks of the process are illustrated in a particular order, in some embodiments, one or more of the blocks may be executed partially or entirely in parallel, may be executed in a different order than illustrated in FIG. 3, or may be bypassed.

In block 305, a control system determines operational data for a power converter system. For example, with reference to FIG. 1, to implement block 305, the control system 105 determines operational data for the power converter system 100, where the power converter system 100 is implementing a multi-level software-defined power converter system 170 as shown in FIG. 2A. With reference to FIG. 2A, in some examples, block 305 is performed by the interconnection management logic 184 of the interconnection management layer 174 determining the operational data 186. The interconnection management logic 184 may be a portion of the control system 105. The interconnection management logic 184 may determine the operational data 186 by retrieving the operational data 186 from a memory (e.g., the memory 157 or 167 of the control system 105). Additionally, in block 305, the interconnection management logic 184 may determine the mode parameter of the operational data 186 indicating the desired mode of operation for the converter system 170, where the mode of operation is associated with mode configuration data.

The interconnection management logic 184 may determine the mode parameter based on a mode signal received from an external source. For example, when the converter system 170 is integrated into an electric vehicle, the mode signal may be received from an EV controller (e.g., a central controller of the electric vehicle). The mode signal may indicate, for example, to enter the single-phase grid-connected battery charging, three-phase grid-connected battery charging, single phase grid supply, three phase grid supply, DC load control, AC output control, traction motor control, etc. The EV controller may generate the signal based on user interaction with the electric vehicle, such as, for example, a power-on button receiving a user press, the electric vehicle being engaged by a user with a connector cable of a charging station, the electric vehicle being engaged by a user with a grid connector cable, etc. The EV controller may translate the user interaction into a mode signal that is provided to the interconnection management logic 184 (e.g., via the I/O interface 142 of FIG. 1). The mode signal may be received over the real-time communication bus 190. In some examples, the mode signal may be generated by another component of the electric vehicle or device into which the converter system 170 is integrated. In some examples, the interconnection management logic 184 may sense a user interaction or other change in circumstance of the converter system 170 that indicates a requested mode change, resulting in an updated mode parameter (and, in some cases, triggering execution of the process 300). Additional description of the operational data 186 is provided above with respect to the interconnection management logic 184.

In block 310, the control system configures, based on the operational data, a power conversion function of the plurality of elementary power converter modules, the power conversion function defining one or more of the elementary power converter modules as active elementary power converter modules for implementing the power conversion function (also referred to as a converter control function). In some examples, with reference to FIG. 2A, block 310 is performed by the interconnection management logic 184 of the interconnection management layer 174. For example, as described above, the operational data 186 may include a mode parameter indicating a desired mode of operation, where the mode is associated with mode configuration data. This mode configuration data may indicate, for the converter system 170, a power conversion application type, a number of conversion stages for the power converter system, a converter topology for each of the conversion stages, and a number of the plurality of elementary module layers for each of the converter topologies, as well as applicable converter control functions 182. Accordingly, the operational data 186 may be indicative of (and/or the interconnection management logic 184 may deduce from the operational data 186 using a set of logic rules or lookup table defined in the interconnection management logic 184) each grouping of the elementary converter modules 177 that will be active and a corresponding control function of the converter control functions 182 to be activated for each grouping.

Then, the interconnection management logic 184 may configure a power conversion function of the plurality of elementary power converter modules 177 by indicating to the global control logic 180 one of the converter control functions 182 to activate and which elementary converter modules 177 are associated with the converter control function 182 that was activated. In some examples, the interconnection management logic 184 may further indicate to the global control logic 180 additional converter control functions 182 to activate and the corresponding elementary converter modules 177 that are to be associated with each respective converter control function 182 that was activated. Additionally, for a particular operation mode of the software-defined power converter system 170, the interconnection management logic 184 may control switches to alter and configure the interconnections between elementary converter modules 177 to achieve the desired power conversion and/or control switches (e.g., of contactor 125) to make or break connections with sources and/or loads 130, 135. Additional description of examples of the interconnection management logic 184 configuring power conversion functions based on the operational data 186 is provided above.

In block 315, the control system determines electrical operating characteristics including an electrical operating characteristic for each of the one or more active elementary power converter modules. In some examples, with reference to FIG. 2A, block 315 is performed by the global control logic 180 of the application function layer 172. The global control logic 180 may be a portion of the control system 105. The particular electrical operating characteristics determined in block 315 may vary depending on the particular configuration of the elementary converter module 177 (e.g., providing DC/DC conversion, AC/DC conversion for charging, DC/AC conversion for motor traction, DC/AC conversion for supply to a grid, etc.), but, in some examples, the electrical operating characteristics may include one or more of: grid current (i_{g}) for each phase, motor current (iₘ) for each phase, inductor current for the LC filter (i_{L}), capacitor voltage (v_{c}), output current (iₒ), battery voltage (v_{batt}), battery current (i_{batt}), dc terminal voltage (v_{dc}). The global control logic 180 of FIG. 2A, which, as noted, may be implemented by the control system 105 of FIG. 1, may determine the electrical operating characteristics based on output from the sensors 140. The sensors 140 may be integrated in the elementary module layer 176 and/or with the elementary converter modules 177. Accordingly, the global control logic 180 may receive, and thereby determine, the electrical operating characteristics from the elementary module layer 176 and/or the elementary converter modules 177. In some examples, one or more of the electrical operating characteristics are inferred or calculated based on output from the sensors. For example, the global control logic 180 may calculate a phase of an output or input signal (e.g., current or voltage) provided by or to each elementary converter module 177. In some examples, in block 315, the global control logic 180 further determines motor characteristics, such as, for example, motor speed (w) and/or motor torque (T), based on output from the sensors 140.

In block 320, the control system generates a control reference target, respectively, for each of the one or more active elementary power converter modules, each control reference target generated based on the electrical operating characteristics. In some examples, with reference also to FIG. 2A, block 320 is performed by the global control logic 180 by executing the converter control function of the converter control functions 182 that is associated with the one or more active elementary power converter modules (e.g., associated by the configuration in block 310). To execute the converter control function, the global control logic 180 may use the electrical operating characteristics as input to the converter control function. By executing the converter control function, the global control logic 180 may generate a control reference target (e.g., vₒ* or v_{c}*) for each elementary converter module 177. Additional description of examples of generating a control reference target (e.g., vₒ* or v_{c}*) is provided below (see, e.g., description with respect to FIGS. 5A-B, 7, and 8).

In examples where the configuration in block 310 results in multiple groups of active elementary converter modules, each with an associated converter control function 182, then, in block 320, the global control logic 180 may execute each associated converter control function 182 to generate a respective control reference target for each elementary converter module 177. For example, the global control logic 180 may execute a first converter control function to generate a control reference target (e.g., vₒ*) for a first elementary converter module 177 implementing DC/DC conversion, and may execute a second converter control function to generate control reference targets (e.g., v_{c_a}*, v_{c_b}*, v_{c_c}*) for second, third, and fourth elementary converter modules 177 grouped to implement DC-to-three-phase-AC conversion (or three-phase AC-to-DC conversion).

In block 325, the control system controls the power switching elements, of each of the one or more active elementary power converter modules, based on the electrical operating characteristic and the control reference target for the active elementary power converter module. In some examples, with reference also to FIG. 2A, block 325 is performed by the local control logic 178 of an elementary converter module 177 controlling a corresponding converter circuit 179 of the elementary converter module 177. The local control logic 178 may be a portion of the control system 105. In some examples, in block 325, the local control logic 178 receives the control reference target from the global control logic 180 that the global control logic 180 generated for the elementary converter module 177. The local control logic 178 then generates control signals for the converter circuit 179 based on the control reference target and the electrical operating characteristic for that elementary converter module 177. The control signals may include a pulse width modulated (PWM) signal for each switching element of the converter circuit 179 (see, e.g., switches 235, 240 in the example converter 200 of FIG. 2B). The PWM signal may have a duty cycle and frequency determined and controlled by the local control logic 178 based on the control reference target and the electrical operating characteristic for the elementary converter module 177. For example, the local control logic 178 may implement one or both of model predictive control (MPC) and variable frequency soft switching, as described in further detail below, to determine the duty cycle and frequency of the control signals.

In some examples, in block 325, each elementary converter module 177 that receives a control reference target generated by the global control logic 180 in block 320 similarly includes a local control logic 178 that controls a corresponding converter circuit 179 according to the control reference target and electrical characteristic for that elementary converter module 177.

The control system 105 (e.g., via the global control logic 180 and local control logic 178 in FIG. 2A) may continue to control the power switching elements of the power converter 115 (e.g., of the converter circuits 179 in FIG. 2A) in block 325 to implement the configured conversion until, for example, a change in circumstances for the system 100 (e.g., as determined by the interconnection management logic 184 of FIG. 2A). Then, the process 300 of FIG. 3 may be repeated by the control system, for example, in response to the change in circumstances. For example, upon the control system 105 (e.g., via the interconnection management logic 184) receiving a new mode signal via the I/O interface 142 and/or communication bus 190 (e.g., from an EV controller, a grid controller, or other device) or upon the control system 105 detecting a new source or load 110, 130, 135 being connected or disconnected from the system 100, the control system 105 may execute the process 300 again, starting at block 305.

In some examples, the multi-level software-defined power converter implementing the process of FIG. 3 includes one or more additional functions or characteristics as described herein. For example, the multi-level software-defined power converter may implement MPC-VFSS control at the elementary power module layer, may implement zero-voltage control (e.g., via the global control logic), and/or may include one or more of the bypass paths provided by the upper or lower capacitors of the LC filter.

Although the power converter system 100 and multi-level software-defined power converter are described herein primarily as non-isolated power converters, in some examples, one or more of the elementary converter modules 177 (see FIG. 2A) may be implemented as an isolated power converter that includes a transformer (see isolated power module of FIG. 2C).

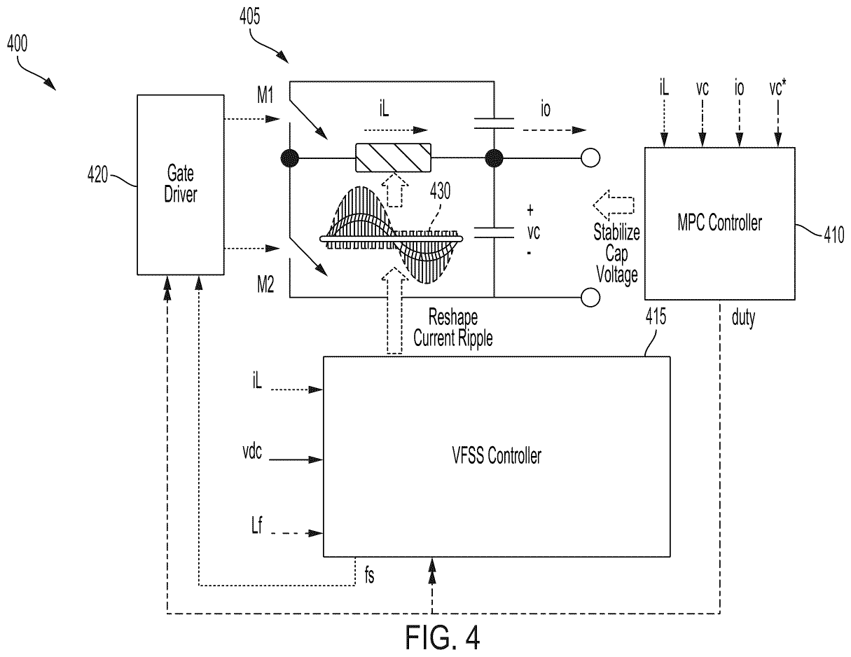

FIG. 4 illustrates a model predictive controller (MPC) variable frequency soft switching (VFSS) converter module 400, herein an MPC-VFSS converter 400. The MPC-VFSS converter 400 includes a converter circuit 405, which may be implemented as the converter 200 of FIG. 2B, an MPC controller 410, a VFSS controller 415, and a gate driver 420. The MPC-VFSS converter 400 is an example of the elementary converter module 177 of FIG. 2A. For example, the MPC controller 410, the VFSS controller 415, and the gate driver 420 of FIG. 4 may serve as the local control logic 178 FIG. 2A, and the converter circuit 405 of FIG. 4 may serve as the converter circuit 179 of FIG. 2A.

As illustrated and described with respect to the converter circuit 200 of FIG. 2B, the MPC-VFSS converter 400 of FIG. 4 includes two switches (M1, M2), an inductor (L), an output upper capacitor, and an output lower capacitor, where the inductor and capacitors form an LC filter for the MPC-VFSS converter 400. Differential equations for the LC filter can be expressed as:

$${i}_{L} ( t ) = - \frac{1}{{L}_{f}} {v}_{c} ( t ) + \frac{{v}_{d c}}{{L}_{f}} d ( t ) \qquad ( 1 )$$

$${v}_{c} ( t ) = \frac{1}{{c}_{f}} {i}_{L} ( t ) - \frac{1}{{c}_{f}} {i}_{o} ( t ) . \qquad ( 2 )$$

In which L_{f} and C_{f} represent, respectively, the phase leg inductor (L) and output lower capacitor, respectively. The variables i_{L}, v_{c}, iₒ, v_{dc} and d are the phase leg inductor current, output capacitor voltage, output current, DC bus voltage, and duty cycle. The MPC controller 410 may implement a local MPC control algorithm that is configured according to the per phase LC filter to track the reference commands (e.g., vc*) from the global control logic 180.

The MPC controller 410 may receive as input i_{L}, v_{c}, iₒ, and the reference command v_{c}*, and generate a duty cycle for PWM signals that the gate driver 420 generates to drive the switches M1 and M2. Generally, the MPC controller 410 determines the duty cycle such that the capacitor voltage v_{c} tracks the reference command v_{c}*.

The VFSS controller may receive the inductor current (i_{L}), dc rail voltage (v_{dc}), and inductance of the inductor (L_{f}), and duty cycle from the MPC controller 410, and determine, based on these inputs, a switching frequency (fₛ). The VFSS controller 415 provides the switching frequency (fₛ) to the gate driver 420, which the gate driver 420 uses for the PWM signals to drive the switches M1 and M2. Generally, the VFSS controller 415 determines the switching frequency (fₛ) such that soft switching is achieved by the converter 405.

Switching losses of the converter 405 may be reduced by implementing soft switching at the local level of the MPC-VFSS converter 400. This reduction can similarly be achieved by each elementary converter module 177 (see FIG. 1B) by implementing similar techniques (e.g., when implemented as the converter 405). The VFSS controller 415 may implement and control the variable frequency soft switching for the converter 405. The soft switching operation aims at substituting M₁ high turn-on switching loss with M₂ low turn-off switching loss. For typical power switches, (e.g., SiC MOSFET of C3M0021120K) applied in the automotive industry and other power switches, the turn-off switching loss may be four times smaller than the turn-on switching loss.

In some examples, to realize soft switching in a two-level converter, the VFSS controller 415 reshapes the phase leg inductor current ripple such that the vertex and nadir points are positive and negative. The vertex and nadir point ripple value should be large enough to guarantee a full soft switching. In the period when M₁ is turned on, the phase leg inductor current is discharging M1 switch capacitor, C_{oss,M1}. The M₁ zero voltage switching can be realized under the circumstance of C_{oss,M1} being completely discharged before M₁ is on. In the same way, a reversed direction from the phase leg inductor current is required to completely discharge M2 switch capacitor, C_{oss,M2}, before M₂ is on. The shape and envelope of phase leg inductor current in sinusoidal mode is shown in curve 430.

The turn-on timing for switching transitions and the least required inductor current ripple are determined by the discharge, Qₘᵢₙ and Qₘₐₓ, of upper/lower switch output capacitors. The phase leg side inductor current vertex/nadir point values, I_{L,max/min}) for critical soft switching operation can be expressed by the drain-source current through the upper and lower switches, i_{DS,M1} and i_{DS,M2}, and the current through the upper and lower switch output capacitance, i_{CDS,M1} and i_{CDS,M2}. The phase leg side inductor current ripple nadir point, I_{L,min}, is taken as an example for the derivation as below:

$${I}_{L , min} = - {i}_{DS , M 2} + {i}_{C D S , M 1} - {i}_{CDS , M 2} , \qquad ( 3 )$$

where the i_{CDS,M1} and i_{CDS,M2} are the derivative functions of upper/lower switch output capacitors, C_{DS,M1} and C_{DS,M2}, and drain-source voltages, v_{DS,M1} and v_{DS,M2}. i_{CDS,M1} can be expressed as:

$${i}_{CDS , M 1} = {C}_{DS , M 1} \frac{d {v}_{DS , M 1}}{dt} . \qquad ( 4 )$$

Then, with the integral calculation in each switching dead time period, ta, the required I_{L,min} at specific dead time can be further expressed by the discharge, Qₘᵢₙ, of upper/lower switch output capacitors as 0.5I_{L,min}t_{d}≤Qₘᵢₙ≤0. The corresponding analytical derivations of I_{L,min} and Qₘᵢₙ are demonstrated as:

$${I}_{L , m l n} = - {i}_{DS , M 2} - ( {C}_{DS , M 1} + {C}_{DS , M 2} ) \frac{d {v}_{DS , M 2}}{dt} and \qquad ( 5 )$$

$${Q}_{min} = {\int }_{0}^{{T}_{d}} [ {I}_{L , m l n} - {i}_{DS , M 2} ( t ) ] d t = {\int }_{0}^{{U}_{i n}} - [ {C}_{DS , M 1} ( {v}_{DS , M 2} ) + {C}_{DS , M 2} ( {v}_{DS , M 2} ) ] d {v}_{DS , M 2} = {\int }_{0}^{{T}_{d}} [ {I}_{L , min} - ( {I}_{L , min} - \frac{{I}_{L , min}}{{T}_{d}} t ) ] d t = \frac{1}{2} {I}_{L , min} {T}_{d} . \qquad ( 6 )$$

Because the least required discharge may be provided by the M₁ and M₂ switch datasheets, and dead time can be pre-defined, the minimum current ripple can then be derived to achieve the soft switching by variable switching frequency.

Thus, the VFSS controller may receive the inductor current (i_{L}), dc rail voltage (v_{dc}), and inductance of the inductor (L_{f}), and duty cycle from the MPC controller 410, and determine from these inputs a switching frequency (fₛ) to achieve soft switching by the converter 405. Additional discussion on VFSS is provided below with respect to equations (33)-(35).

As described above, the interconnection management logic 184 can configure the converter system 170 into various configurations for implementing various modes, each configuration resulting in certain elementary converter modules 177 activated and/or grouped, and resulting in use of specific converter control functions 182 for controlling the elementary converter modules 177. FIGS. 5A-B, 7, and 8 provides example configurations and modes of operation of the converter system 170, including single-phase grid electric vehicle (EV) charging, three-phase grid EV charging, EV motor traction. Common mode control for the output capacitor voltage of the designed non-isolated EV system is also described further.

### Single-Phase Grid-Based Charging

FIGS. 5A-B illustrates an example of the converter system 170 configured in a single-phase grid EV charging mode configuration 500. The illustration is split across FIG. 5A and FIG. 5B, with FIG. 5A showing the application layer 172 and FIG. 5B illustrated other components of the converter system 170. In FIGS. 5A-B, the interconnection management layer 174, communication bus 190, and other aspects of the converter system 170 are not illustrated. However, these components may still be present in the converter system 170 of FIGS. 5A-B and, for example, communications illustrated and described with respect to FIGS. 5A-B may occur over the communication bus 190.

In the configuration 500, a first elementary converter module 177, identified as module 177a, is a DC/DC converter and two elementary converter modules 177, identified as modules 177b and 177c, may be connected in parallel to formulate a single-phase H-bridge grid-connected converter (which is bidirectional, and may be transformerless). The state space equations for this converter in the ab reference frame (or, coordinate system) are derived as:

$${i}_{L , a b} = \frac{1}{{L}_{f}} {I}_{1 ϕ} {v}_{x , a b} - \frac{1}{{L}_{f}} {I}_{1 ϕ} {v}_{c , ab} \qquad ( 7 )$$

$${\dot{v}}_{c , a b} = \frac{1}{{C}_{f}} {I}_{1 ϕ} {i}_{L , a b} - \frac{1}{{C}_{f}} {I}_{1 ϕ} {i}_{g , ab} \qquad ( 8 )$$

$${i}_{g , ab} = \frac{1}{{L}_{g}} {I}_{1 ϕ} {v}_{c , a b} - \frac{1}{{L}_{g}} {I}_{1 ϕ} {v}_{g , ab} , \qquad ( 9 )$$

in which L_{f}, C_{f} and L_{g} are the phase leg inductor, output capacitor and output inductor. i_{L,ab}, v_{c,ab}, i_{g,ab} and v_{x,ab} are the phase leg inductor current, output capacitor voltage, output side current and grid voltage for the single-phase grid-tied system. I_{1φ}∈ [symbol] ^{2×2} is the identity matrix for single-phase grid connection system.

Leveraging the Park and Clarke transformations, the state space equations are able to be transferred from the ab coordinate system to the dq0 coordinate system to implement the central level control of the global control logic 180:

$${i}_{L , d q 0} = \frac{1}{{L}_{f}} {l}_{d q 0} {v}_{x , d q 0} - \frac{1}{{L}_{f}} {l}_{d q 0} {v}_{c , d q 0} - ω S {i}_{L , d q 0} \qquad ( 10 )$$

$${\dot{v}}_{c , d q 0} = \frac{1}{{C}_{f}} {I}_{d q 0} {i}_{L , d q 0} - \frac{1}{{C}_{f}} {I}_{d q 0} {i}_{g , dq 0} - ω S {v}_{c , d q 0} \qquad ( 11 )$$

$${i}_{g , dq 0} = \frac{1}{{L}_{g}} {I}_{d q 0} {v}_{c , d q 0} - \frac{1}{{L}_{g}} {I}_{dq 0} {v}_{g , dq 0} - ω S {i}_{g , dq 0} \qquad ( 12 )$$

in which ω is the grid angular speed with the unit of rad/s. S is [0, −1, 0; 1, 0, 0; 0, 0, 0] for the coupling terms of single-phase grid-connection model. I_{dq0} ∈ [symbol] ^{3x3} is the unit matrix for dq0 grid connection coordinate system.

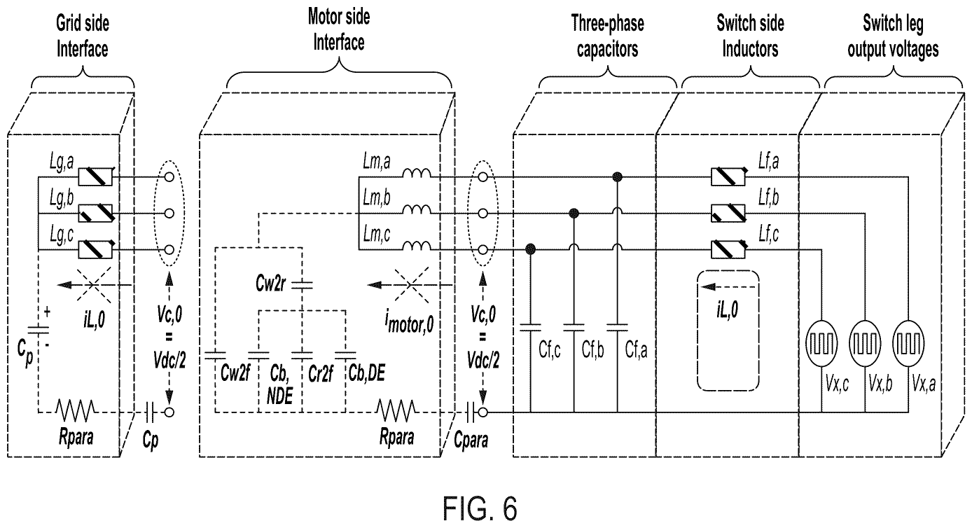

Different from other converter topologies, the upper and lower output capacitors of the elementary converter modules 177b, 177c provide common mode leakage current bypassing paths for the converter (see, e.g., FIG. 6). The common mode voltage of single-phase topology can be derived as:

$${v}_{c m , 1 ϕ} = {v}_{c 0 , 1 ϕ} = \frac{{v}_{c , a} + {v}_{c , b}}{2} . \qquad ( 13 )$$

Since the common mode voltage is measured as the mean value of output side lower capacitor voltage for the single-phase (and three-phase) DC/AC side converters and the lower capacitors have been connected to the negative DC bus terminal, the common mode voltage will then have an offset of half of DC bus (v_{dc}/2). The leakage current may be caused by the pulsation from the common mode voltage at a high-level frequency to be injected into the grid through a parasitic capacitor, Cₚₐᵣₐ. The leakage current is defined as:

$${i}_{lkg , 1 ϕ} = {i}_{g 0 , 1 ϕ} = {C}_{p a r a} \frac{d {v}_{c 0 , 1 ϕ}}{dt} . \qquad ( 14 )$$

With the two elementary converter modules 177b, 177c connected in parallel and configured as an converter, combined with the elementary converter modules 177a configured as a DC/DC converter, the corresponding zero sequence circuitry (e.g., as illustrated in FIG. 6) demonstrates that the leakage current can be bypassed by the upper/lower output capacitors with the help of the local control logic 178 (e.g., implementing model predictive control) in each elementary converter module 177b, 177c to stabilize the zero sequence component. From the control aspect, this configuration can stabilize the common mode component, v_{c0,1φ}, to be fixed as half of DC bus. Then, according to (14), the leakage current flowing to the grid will be largely attenuated.

Returning to FIGS. 5A-B, converter control functions (e.g., selected from the converter control functions 182 of FIG. 2A) that are configured for implementation by the global control logic 180 are illustrated. In particular, a DC/DC converter function 510 of the converter control functions 182 and a single-phase H-bridge transformerless-capable grid-connected converter function 515 (converter function 515) are illustrated as functional block diagrams within the global control logic 180. Each block within these functional block diagrams may be implemented by the control system 105 by, for example, a hardware circuit, instructions executed by a processor, or a combination thereof.

The DC/DC converter function 510 provides a reference command (or target) in the form of a reference output voltage (vₒ*) to the local control logic 178 of the elementary converter module 177a. As illustrated in FIGS. 5A-B, the DC/DC converter function 510 may implement a constant voltage (CV) control and a constant current (CC) control (CV/CC control), where the CV and CC control are cascaded, to generate the reference output voltage (vₒ*). For example, the CV/CC control may use a reference battery voltage and a sensed battery voltage to generate a reference inductor current, and use the reference inductor current and a sensed inductor current to generate the reference output voltage (vₒ*). The local control logic 178 may receive the reference output voltage (vₒ*) and, based on the reference output voltage (vₒ*), generate a switching frequency (f_{s, dc}) and duty cycle (d_{dc}) to control the switches M₁ and M₂ of the converter circuit 179 of the elementary converter module 177a. The switching frequency (fₛ, d_{c}) and duty cycle (d_{dc}) may be generated using, for example, model predictive control (MPC) and variable frequency soft switching (VFSS) such that the voltage (vₒ) across the lower capacitor c_{f,lo} of the converter circuit 179 tracks the reference output voltage (vₒ*). Accordingly, the DC/DC converter function 510 may thereby control the charging power supplied by the elementary converter module 177a to a battery 520 (or discharging of power from the battery 520). In some examples, the elementary converter module 177a implementing the DC/DC stage is configured with the MPC to stabilize the capacitor voltage. In other examples, the elementary converter module 177a may directly pass the reference output voltage (vₒ*) to a gate driver (see gate driver 420 of FIG. 4) that generates the PWM modulation for the switches M₁ and M₂.

The DC/DC converter function 510 may also include a DC bus voltage controller to generate a reference grid current for use by the converter function 515. The DC link voltage between the DC/AC and DC/DC energy conversion stages in the configuration 500 is controlled with the DC bus voltage controller to provide the reference grid current (i_{g,d}*) for the output side current controller.

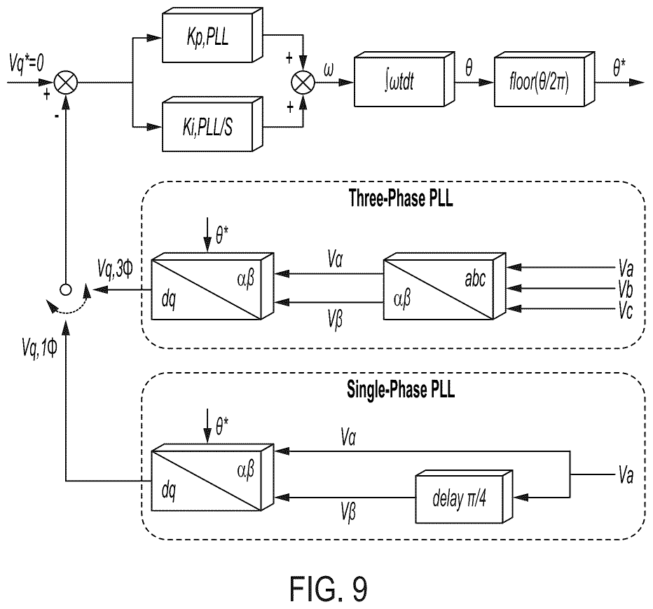

The converter function 515 provides a reference command (or target) in the form of a reference capacitor voltage (v_{c}*) for each leg of the converter formed by the elementary converter modules 177b, 177c. More particularly, the converter function 515 generates a first reference capacitor voltage (v_{c,a}*) and a second reference capacitor voltage (v_{c,b}*). To do so, the converter function 515 may receive one or more of grid current (i_{g}), inductor current (i_{L}), output voltage (v_{c}) measured at the converter circuits 179 of each respective elementary converter module 177a, 177b, 177c. Additionally, the converter function 515 may implement a single-phase phase-lock loop (PLL) to estimate a phase (theta*) of the configuration 500. An example of the single phase PLL is illustrated in FIG. 9. As illustrated in FIG. 9, the virtual αβ components of output capacitor voltage are constructed and transformed to the dq reference frame to control the q component to be zero for the generation of an accurate grid angular speed, ω, and phase angle, θ (i.e., theta).

The converter function 515 may translate the receive grid current (i_{g}), inductor current (i_{L}), and output voltage (v_{c}) to the dq reference frame (e.g., using theta*, as illustrated). The converter function 515 may use the grid current in the dq reference frame (i_{g,dg0}) to generate the reference command. More particularly, the converter function 515 may include two regulators (e.g., PID or PI controllers) that control the grid side inductor current dq components, i_{g,dg0}, to generate the references for the output capacitor voltage in the dq reference frame,

$${v}_{c , dq}^{*} .$$

Further, the converter function 515 may set the reference for zero sequence component of output capacitor voltage,

$${v}_{c , 0}^{*} ,$$

to halt of DC bus voltage, v_{dc}. Then, the dq0 components of output capacitor voltage references are transformed into ab reference frame with the reversed Park and Clarke functions as,

$${v}_{c , ab}^{*} .$$

The converter function 515 may then provide the generated

$${v}_{c , ab}^{*}$$

as the reference command (or target), in the form of a reference capacitor voltage (v_{c}*) for each leg, to the local control logic 178 of each of the elementary converter modules 177b, 177c.

As noted, the local control logic 178 of each of the elementary converter modules 177a, 177b, 177c may output sensor data (e.g., captured via sensors 140, FIG. 1) to the DC/DC converter function 510 and the converter function 515, for use by these functions. For example, the elementary converter modules 177a, 177b, 177c may output one or more of grid current (i_{g}), inductor current (i_{L}), output voltage (v_{c}) measured, at the converter circuits 179 of each respective elementary converter module 177a, 177b, 177c, to these functions 510, 515 of the global control logic 180.

The local control logic 178 of each of the elementary converter modules 177b, 177c may receive one of the reference output voltages (v_{c,a}*, v_{c,b}*) and, based on the reference output voltages, generate, respectively, a switching frequency (f_{s,a}, fₛ,b) and duty cycle (dₐ,d_{b}) to control the switches M1 and M2 of the corresponding converter circuit 179 of the elementary converter module 177b, 177c. The switching frequency (fₛ) and duty cycle (d), from each logic control logic 178, may be generated using, for example, model predictive control (MPC) and variable frequency soft switching (VFSS) such that the voltage (v_{c,a}, v_{c,b}) across the lower capacitors (c_{f,lo}) of the converter circuits 179 tracks the reference output voltage (v_{c,a}*, v_{c,b}*). Accordingly, the converter function 515 may thereby control the DC power supplied to the elementary converter module 177a, that is converted from AC power received from a grid 525. Although not illustrated in FIGS. 5A-B, the contactor 125 (see FIG. 1) may couple the elementary module layer 176 with the grid 525 at the power connection point (PCC).

Each block in the global control logic 180 that receives a reference value (designated with an asterisk (*)) and a corresponding sensed value may serve as a regulator (e.g., a PI regulator, PID regulator, etc.) that, for example, increases or decreases the output of the block to enable the sensed value to track the reference value.

### Three-Phase EV Grid-Based Charging

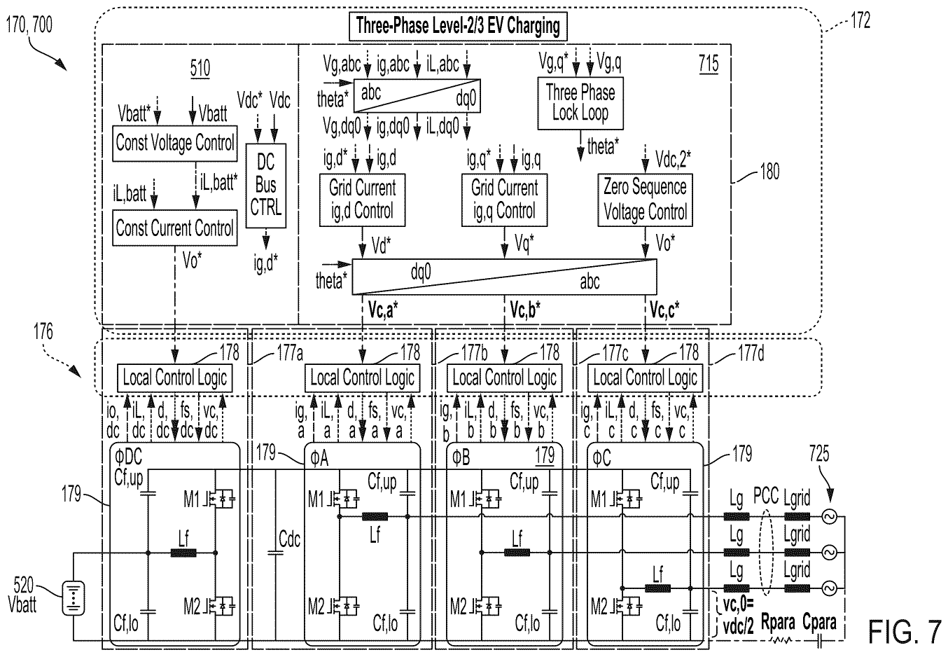

FIG. 7 illustrates an example of the converter system 170 configured in a three-phase grid EV charging mode configuration 700. In FIG. 7, the interconnection management layer 174, communication bus 190, and other aspects of the converter system 170 are not illustrated. However, these components may still be present in the converter system 170 of FIG. 7 and, for example, communications illustrated and described with respect to FIG. 7 may occur over the communication bus 190.

In the configuration 700, a first elementary converter module 177, identified as module 177a, is a DC/DC converter and three elementary converter modules 177, identified as modules 177b, 177c, and 177d, may be connected in parallel to formulate a three-phase H-bridge grid-connected converter (which is bidirectional and may be transformerless).

The state space equation via abc reference frame is similar to equations (7)-(9) by substituting i_{L,ab}, v_{c,ab}, i_{g,ab}, v_{x,ab} and I_{1φ}∈ [symbol] ^{2×2} with i_{L,abc}, v_{c,abc}, i_{g,abc} and v_{x,abc} and I_{3φ}∈ [symbol] ^{3×3} for the three-phase system.

Leveraging the Park and Clarke transformations, the state space equations of three-phase system can be transferred into the dq0 coordinate system for implementing the central level control which are similar to equations (10)-(12) in the single-phase system.

Different from some three-phase topologies, the output side of upper and lower capacitors of the elementary converter modules 177b, 177c, 177d provide common mode leakage current bypassing paths for the formulated three-phase grid-tied inverter (e.g., as illustrated in FIG. 6). The common mode voltage and the corresponding leakage current expressions are similar to equations (13) and (14) by transferring single-phase variables into three-phase system.

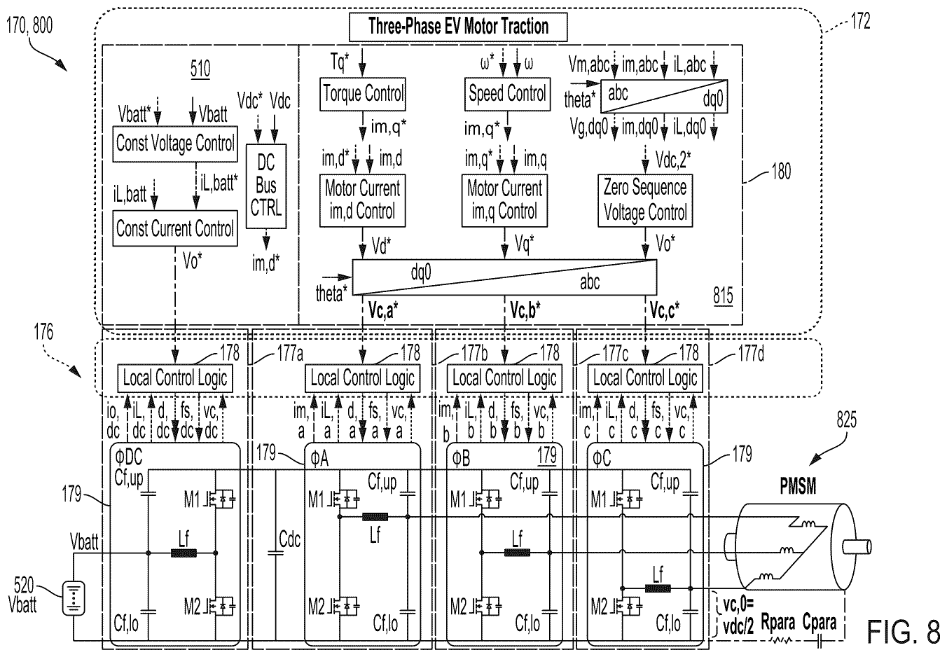

With the three elementary converter modules 177b, 177c, 177d connected in parallel for three-phase grid-connected DC/AC converter combined with the elementary converter modules 177a configured as a DC/DC converter, as demonstrated in FIG. 8, the corresponding zero sequence circuitry (e.g., as illustrated in FIG. 6) demonstrates that the leakage current can be bypassed by the upper/lower output capacitors with the help of local control logic 178 in each elementary converter module 177b-d to stabilize the zero sequence component. From the control aspect, the embedded local power module zero sequence voltage MPC can stabilize the common mode component, v_{c0,3φ}, to be fixed as half of DC bus. Then, the leakage current flowing to the grid will also be largely attenuated.

Returning to FIG. 7, converter control functions (e.g., selected from the converter control functions 182 of FIG. 2A) that are configured for implementation by the global control logic 180 are illustrated. In particular, a DC/DC converter function 510 of the converter control functions 182 and a three-phase H-bridge transformerless-capable grid-connected converter function 715 (converter function 715) are illustrated as functional block diagrams within the global control logic 180. Each block within these functional block diagrams may be implemented by the control system 105 by, for example, a hardware circuit, instructions executed by a processor, or a combination thereof.

The DC/DC converter function 510 of FIG. 7 may be configured and function similarly to the DC/DC converter function 510 of FIGS. 5A-B. Accordingly, for example, the DC/DC converter function 510 provides a reference command (or target) in the form of a reference output voltage (vₒ*) to the local control logic 178 of the elementary converter module 177a.

The converter function 715 provides a reference command (or target) in the form of a reference capacitor voltage (v_{c}*) for each leg of the converter formed by the elementary converter modules 177b, 177c, 177d. More particularly, the converter function 715 generates a first reference capacitor voltage (v_{c,a}*), a second reference capacitor voltage (v_{c,b}*), and a third reference capacitor voltage (v_{c,c}*).

The local control logic 178 of each of the elementary converter modules 177a, 177b, 177c, 177d may output sensor data (e.g., captured via sensors 140, FIG. 1) to the DC/DC converter function 510 and the converter function 715, for use by these functions. For example, the elementary converter modules 177a, 177b, 177c, 177d may output one or more of grid current (i_{g}), inductor current (i_{L}), output voltage (vₒ) measured, at the converter circuits 179 of each respective elementary converter module 177a, 177b, 177c, 177d, to these functions 510, 715 of the global control logic 180.

The local control logic 178 of each of the elementary converter modules 177b, 177c, 177d may receive one of the reference output voltages (v_{c,a}*, v_{c,b}*, v_{c,c}*) and, based on the reference output voltages, generate, respectively, a switching frequency (f_{s,a}, f_{s,b}, f_{s,c}) and duty cycle (dₐ, d_{b}, d_{c}) to control the switches M1 and M2 of the corresponding converter circuit 179 of the elementary converter module 177b, 177c, 177d. The switching frequency (fₛ) and duty cycle (d), from each logic control logic 178, may be generated using, for example, model predictive control (MPC) and variable frequency soft switching (VFSS) such that the voltage (v_{c,a}, v_{c,b}, v_{c,c}) across the lower capacitors (c_{f,lo}) of the converter circuits 179 tracks the reference output voltage (v_{c,a}*, v_{c,b}*, v_{c,c}*). Accordingly, the converter function 715 may thereby control the DC power supplied to the elementary converter module 177a, that is converted from AC power received from a three phase AC grid 725. Although not illustrated in FIG. 7, the contactor 125 (see FIG. 1) may couple the elementary module layer 176 with the grid 725 at the power connection point (PCC).

Each block in the global control logic 180 that receives a reference value (designated with an asterisk (*)) and a corresponding sensed value may serve as a regulator (e.g., a PI regulator, PID regulator, etc.) that, for example, increases or decreases the output of the block to enable the sensed value to track the reference value.

### EV Motor Traction Drive

FIG. 8 illustrates an example of the converter system 170 configured in a three-phase motor traction inverter configuration 800 (also referred to as the traction motor configuration 800 or EV motor traction drive configuration 800), which is bidirectional and may be transformerless. In FIG. 8, the interconnection management layer 174, communication bus 190, and other aspects of the converter system 170 are not illustrated. However, these components may still be present in the converter system 170 of FIG. 8 and, for example, communications illustrated and described with respect to FIG. 8 may occur over the communication bus 190.

In the configuration 800, a first elementary converter module 177, identified as module 177a, is a DC/DC converter and three elementary converter modules 177, identified as modules 177b, 177c, and 177d, may be connected in parallel to formulate a three-phase transformerless motor traction inverter. Unlike the grid-connected inverter applications of FIGS. 7-8 interfacing with the grid 525, 725, the configuration 800 interfaces with a motor 825 without the grid side inductors, L_{g}. The three elementary converter modules 177b-d can be directly connected to the motor 825. Thus, motor drive modeling for the43onfigureation 800 Can be separated into switch side LC filter modeling and permanent magnet synchronous motor (PMSM) modeling.

For the switch side LC filter modeling, the state space equations via abc coordinate system are derived as:

$${i}_{L , a b c} = \frac{1}{{L}_{f}} {I}_{3 ϕ} {v}_{x , abc} - \frac{1}{{L}_{f}} {I}_{3 ϕ} {v}_{c , abc} \qquad ( 15 )$$

$${\dot{v}}_{c , a b c} = \frac{1}{{C}_{f}} {I}_{3 ϕ} {i}_{L , a b c} - \frac{1}{{C}_{f}} {I}_{3 ϕ} {i}_{motor , abc} \qquad ( 16 )$$

in which i_{motor,abc} is the current flowing into a motor winding of the motor 825. Leveraging the Park and Clarke transformations, the state space equations can be transferred into the dq0 coordinate system to implement the central level control of the global control logic 180

$${i}_{L , d q 0} = \frac{1}{{L}_{f}} {I}_{d q 0} {v}_{x , d q 0} - \frac{1}{{L}_{f}} {I}_{d q 0} {v}_{c , d q 0} - ω M {i}_{L , d q 0} \qquad ( 17 )$$

$${\dot{v}}_{c , d q 0} = \frac{1}{{C}_{f}} {I}_{d q 0} {i}_{L , d q 0} - \frac{1}{{C}_{f}} {I}_{d q 0} {i}_{motor , dq 0} - ω M {v}_{c , d q 0} \qquad ( 18 )$$

in which M is the matrix, [0, −1, 0; 1, 0, 0; 0, 0, 0], for the coupling terms of motor drive model.

In an example for the motor side modeling, a typical PMSM may be used. In contrast to the grid side inductor current, i_{g,dg0}, the motor windng current, i_{motor,dq0}, can be modeled as:

$${i}_{motor , d} = \frac{1}{{L}_{d}} ( {v}_{c , d} - {R}_{s} {i}_{motor , d} + {ω}_{e} {L}_{q} {i}_{motor , q} ) \qquad ( 19 )$$

$${i}_{motor , q} = \frac{1}{{L}_{q}} ( {v}_{c , q} - {R}_{s} {i}_{motor , q} - {ω}_{e} ( {L}_{d} {i}_{motor , d} + ψ ) ) \qquad ( 20 )$$

$${T}_{e} = \frac{3}{2} p ( λ {i}_{m o t o r , q} + ( {L}_{d} - {L}_{q} ) {i}_{motor , d} {i}_{motor , q} ) \qquad ( 21 )$$

$${\dot{ω}}_{e} = \frac{1}{J} ( - B {ω}_{e} + p {T}_{e} - p {T}_{l} ) \qquad ( 22 )$$

in which L_{d}, L_{q} represent the dq component inductance of the motor 825; Rₛ represents the equivalent winding resistor of a stator of the motor 825; ψ demonstrates a permanent magnet flux; ωₑ stands for a rotor electrical angular speed that is related to the mechanical angular speed, ωₘ, of the motor 825, with pairs of pole, pp. The relation can be represented as ωₑ=pₚωₘ·Tₑ and Tₗ are electrical and load torques of the motor 825, respectively. B and J are friction and inertia coefficients of the motor 825, respectively.

Motor bearing current and shaft voltage of the motor 825 caused by the switching pulsation of a traction inverter, such as illustrated in FIG. 8, is a factor that can result in failure of the motor 825. The upper and lower output capacitors of the elementary converter modules 177b-d can provide common mode leakage current bypassing paths for the formulated motor traction inverter (e.g., as illustrated in FIG. 6). The common mode voltage of the motor traction inverter topology of the configuration 800, which is highly related to the shaft voltage of the motor can be derived as:

$${v}_{c m , motor} = {v}_{C f 0 , motor} = \frac{{v}_{Cf , a} + {v}_{Cf , b} + {v}_{Cf , c}}{3} . \qquad ( 23 )$$

For the configuration 800 and the motor 825, the leakage current is also typically generated due to zero sequence voltage pulsation at a high-level frequency, which can be injected into the motor bearing through the parasitic capacitor, Cₚₐᵣₐ. An equivalent parasitic circuit model for the motor system has been displayed in FIG. 6, which includes two paths. The first parasitic path is from the stator windings to the frame of the motor, C_{w2f}. The second path includes two cascaded sections which are from the stator windings to the rotor, C_{w2r}, and then from the rotor to the frame, C_{r2f}, C_{bD,NDE}, C_{b,DE}. The leakage current, i_{lkg,motor}, generated due to the zero sequence voltage pulsation at a high level frequency mainly flows through the first path of stator windings to the frame capacitor, C_{w2f}, because of its low impedance. And, the second path of leakage current is mostly relevant to the bearing current and bearing voltage, which are also generated due to the zero sequence voltage pulsation at a high level frequency. Specifically, C_{w2r}, C_{r2f}, C_{b,NDE} and C_{b,DE} are the stator windings to rotor capacitor, rotor to frame capacitor, non-drive end and drive end capacitors, respectively. So, the equivalent parasitic capacitance can be derived as:

$${C}_{p a r a} = \frac{( {C}_{r 2 f} + {C}_{b , NDE} + {C}_{b , DE} ) {C}_{w 2 r}}{( {C}_{r 2 f} + {C}_{b , NDE} + {C}_{b , DE} ) + {C}_{w 2 r}} + {C}_{w 2 f} . \qquad ( 24 )$$

Thus, the leakage current also regarded as the bearing current is defined as:

$${i}_{lkg , mofor} = {i}_{0 , motor} = {C}_{p a r a} \frac{d {v}_{c 0 , motor}}{dt} . \qquad ( 25 )$$

With the three elementary converter modules 177b, 177c, 177d connected in parallel for the modified motor traction inverter combined with the elementary converter modules 177a configured as a DC/DC converter as demonstrated in FIG. 8, the corresponding zero sequence circuitry (e.g., as illustrated in FIG. 6) demonstrates that the leakage current can be bypassed by the upper/lower output capacitors the help of local control logic 178 in each elementary converter module 177b-d to stabilize the zero sequence component. From the control aspect, the embedded local power module zero sequence voltage MPC can stabilize the common mode component, v_{c0,motor}, to be fixed as half of DC bus. Then, according to (25), the leakage current flowing to the motor bearing of the motor 825 will also be largely attenuated.

Returning to FIG. 8, converter control functions (e.g., selected from the converter control functions 182 of FIG. 2A) that are configured for implementation by the global control logic 180 are illustrated. In particular, a DC/DC converter function 510 of the converter control functions 182 and a three-phase transformerless-capable motor traction inverter function 815 (motor inverter function 815) are illustrated as functional block diagrams within the global control logic 180. Each block within these functional block diagrams may be implemented by the control system 105 by, for example, a hardware circuit, instructions executed by a processor, or a combination thereof.

The DC/DC converter function 510 of FIG. 8 may be configured and function similarly to the DC/DC converter function 510 of FIGS. 5A-B. Accordingly, for example, the DC/DC converter function 510 provides a reference command (or target) in the form of a reference output voltage (v₀*) to the local control logic 178 of the elementary converter module 177a. However, in the configuration 800, the DC/DC converter function 510 may control the corresponding elementary converter module 177a to convert DC power from the battery 520 and output DC power to DC rails of the converter circuits 179 of the other elementary converter modules 177b-d. In some examples, the elementary converter module 177a may boost a voltage level of the DC power from the battery 520 (e.g., from a first DC voltage level to a second DC voltage level that is higher than the first DC voltage level). Accordingly, a battery 520 that outputs the first (lower) DC voltage can be used to drive an inverter (implemented by the elementary converter modules 177b-d) with the second (higher) DC voltage. Alternatively, the elementary converter module 177a can also be used to step voltage down (e.g., from high voltage to low voltage system).

The motor inverter function 815 provides a reference command (or target) in the form of a reference capacitor voltage (v_{c}*) for each leg of the motor inverter formed by the elementary converter modules 177b, 177c, 177d. More particularly, the motor inverter function 815 generates a first reference capacitor voltage (v_{c,a}*), a second reference capacitor voltage (v_{c,b}*), and a third reference capacitor voltage (v_{c,c}*). To do so, the motor inverter function 815 includes torque and speed control blocks configured and cascaded with motor current controllers. The motor inverter function 815 may receive position information of a rotor of the motor (e.g., from an encoder of the sensors 140) indicative of motor speed (ωₘ). The motor speed control block may be designed as a regulator to maintain the motor speed ωₘ) at a desired motor speed (ωₘ*). The output value of the motor speed control block (iₘ,q*) may be configured as the q-axis component of the motor output current reference. The motor inverter function 815 controls the dq-axis components of the motor output current (iₘ) separately with two current control blocks (e.g., PI or PID controllers) to derive the dq components of the output capacitor voltage references (v_{d}*, v_{q}*). The zero-component of the output capacitor voltage reference (v₀*) may be configured as half of the DC bus to stabilize the common mode voltage and leakage current. Finally, the dq0 components of the output capacitor voltage references are converted to the abc reference frame for per phase reference commands to control the elementary converter modules 177a-c.

The local control logic 178 of each of the elementary converter modules 177a, 177b, 177c, 177d may output sensor data (e.g., captured via sensors 140, FIG. 1) to the DC/DC converter function 510 and the motor inverter function 815, for use by these functions. For example, the elementary converter modules 177a, 177b, 177c, 177d may output one or more of grid current (i_{g}), inductor current (i_{L}), output voltage (vₒ) measured, at the converter circuits 179 of each respective elementary converter module 177a, 177b, 177c, 177d, to these functions 510, 815 of the global control logic 180.

The local control logic 178 of each of the elementary converter modules 177b, 177c, 177d may receive one of the reference output voltages (v_{c,a}*, v_{c,b}*, v_{c,c}*) and, based on the reference output voltages, generate, respectively, a switching frequency (f_{s,a}, f_{s,b}, f_{s,c}) and duty cycle (dₐ, d_{b}, d_{c}) to control the switches M1 and M2 of the corresponding converter circuit 179 of the elementary converter module 177b, 177c, 177d. The switching frequency (fₛ) and duty cycle (d), from each logic control logic 178, may be generated using, for example, model predictive control (MPC) and variable frequency soft switching (VFSS) such that the voltage (v_{c,a}, v_{c,b}, v_{c,c}) across the lower capacitors (c_{f,lo}) of the converter circuits 179 tracks the reference output voltage (v_{c,a}*, v_{c,b}*, v_{c,c}*). Accordingly, the motor inverter function 815 may thereby control the AC power supplied to the motor 825 that is converted from DC power received from the battery 520 via the elementary converter module 177a. And, in at least some examples, the configuration 800 provides a motor traction controller with zero-sequence voltage control for the attenuation of the common mode voltage, shaft voltage and bearing current; and local MPC-based control in each elementary converter module 177 for the improvement of the dynamic performance. Although not illustrated in FIG. 8, the contactor 125 (see FIG. 1) may couple the elementary module layer 176 with the motor 825. Accordingly, the contactor 125 may selectively couple the system 170 to the motor 825 such that, when controlled to another configuration (e.g., configuration 500 or 700 of FIGS. 5A-Band FIG. 7), the contactor may selectively couple the system 170 to the grid 525 or 725, as appropriate.

Each block in the global control logic 180 that receives a reference value (designated with an asterisk (*)) and a corresponding sensed value may serve as a regulator (e.g., a PI regulator, PID regulator, etc.) that, for example, increases or decreases the output of the block to enable the sensed value to track the reference value.

### MPC Control

As used herein, MPC control can refer to a control algorithm that relies on or is aware of a system dynamic (e.g., implements or uses a dynamic model representing the converter under control) and predicts, through computation based on electrical characteristics of a converter and a dynamic model, input commands or reference values to control the system's behavior. Accordingly, MPC control, as used herein, may refer to a model predictive control algorithm in a stricter use of the term (such as described in further detail below) as well as other dynamic prediction algorithms (e.g., a linear-quadratic regulator (LQR) control algorithm).

In one example, to implement the MPC algorithm for a particular phase, a controller implementing MPC control for a power converter may, in each control period, solve a cost function using the electrical characteristics and the control reference target for that phase. By solving the cost function, the controller can predict future steps of control signaling to actuate switches of the converter to control power output by the power converter to trend towards the control reference target. The controller may then generate the control signaling for that particular converter based on a first step of the future steps of control signals. Accordingly, in contrast to a proportional integral (PI) control algorithm, the MPC algorithm derives an optimal duty cycle by processing a state variable and tracking error in a linear way with specific coefficients. Because no integration procedure is needed in MPC control, the dynamic performance of MPC control may be improved relative to a PI technique with less overshoot and higher tracking speed. Additionally, because MPC control has higher control bandwidth, MPC control can provide an active damping term to mitigate (reduce or eliminate) LC or LCL resonance that may otherwise be present in a filter circuit of the converter.

As is shown in FIGS. 5A-B, the elementary module layer 176 of the single-phase grid EV charging configuration 500 includes two elementary converter modules 177b, 177c implementing a single-phase DC/AC inverter stage and one elementary converter module 177a implementing a DC/DC converter state. In some examples, each of the elementary converter modules 177 is implementing MPC-VFSS-based control. In some examples, each of the elementary converter modules 177b, 177c is implementing an identical MPC function for the phase leg side LC filtering circuit for the purpose of following the reference command (output capacitor voltage,

$${v}_{c , ab}^{*}$$

), received from the inverter function 515. Also, each of the elementary converter modules 177b, 177c may implement variable-frequency soft-switching (VFSS) control (e.g., to improve the efficiency by adjusting the switching frequency) as described with respect to FIG. 4 and further below.

With reference back to FIGS. 4 and 5, in some examples, to implement the MPC control, at each cycle or control interrupt, the MPC controller 410 (of each elementary converter module 177b, 177c) receives the inductor current, i_{L,ab}, the output capacitor voltage, v_{c,ab}, and the output side current, i_{g,ab}, that is measured or sensed (e.g., by the sensors 140) and the reference command (output capacitor voltage,

$${v}_{c , ab}^{*}$$

) that is received from the inverter function 515. For example, the MPC controller 410 of the elementary converter module 177b (phase a leg) receives i_{L,a}, v_{c,a}, i_{g,a}, and

$${v}_{c , b}^{*} .$$

while the the MPC controller 410 of the elementary converter module 177c (phase b leg) receives i_{L,b}, v_{c,b}, i_{g,b}, and

$${v}_{c , a}^{*} ,$$

Each MPC controller 410 may then explicitly find an active region, s, with the searching matrices, H_{s,c} and K_{s,c}, and derive an optimal duty cycle (d) based on the calculation matrices, F_{s,c} and G_{s,c}. Each MPC controller 410 may then output the duty cycle (d) determined, for use by the VFSS controller 415 and/or gate driver 420 of the corresponding local elementary converter module 177.

The explicit MPC searching and calculation matrices may be derived from the state space equations of the phase leg side LC filtering circuit. The discrete format of the continuous equations in can be expressed as:

$${i}_{L} ( k + 1 ) = {i}_{L} ( k ) - \frac{{T}_{s}}{{L}_{f}} {v}_{c} ( k ) + \frac{{v}_{d c} {T}_{s}}{{L}_{f}} d ( k ) \qquad ( 26 )$$

$${v}_{c} ( k + 1 ) = \frac{{T}_{s}}{{c}_{f}} {i}_{L} ( k ) + {v}_{c} ( k ) - \frac{{T}_{s}}{{c}_{f}} {i}_{g} ( k ) . \qquad ( 27 )$$

To adjust the DC link voltage with the model predictive control function in a more flexible way, the item of v_{dc}d(k) may be substituted with the middle point voltage of the switch leg, vₓ (k). Thus, the corresponding standardized matrix can be demonstrated as

$${X}_{k + 1} = {A}_{C} {X}_{k} + {B}_{C} {u}_{k} + {E}_{C} {e}_{k} \qquad ( 28 )$$

in which the variables and parameters stand for

$${A}_{C} = [ \begin{matrix}1 & - \frac{{T}_{s}}{{L}_{f}} \\ \frac{{T}_{s}}{{C}_{f}} & 1 \\ & \end{matrix} ] , {B}_{C} = [ \begin{matrix}\frac{{T}_{s}}{{L}_{f}} & \\ 0 & \\ & \end{matrix} ] , {E}_{C} = [ \begin{matrix}0 & \\ - \frac{{T}_{s}}{{C}_{f}} & \\ & \end{matrix} ] , \qquad ( 29 )$$

$${X}_{k} = [ \begin{matrix}\begin{matrix}{i}_{L} ( k ) \\ {v}_{c} ( k )\end{matrix} \\ \end{matrix} ] , {u}_{k} = [ {v}_{d c} d ( k ) ] , {e}_{k} = [ {i}_{g} ( k ) ] . \qquad ( 30 )$$

The model predictive control references of phase leg inductor current/output capacitor voltage can be demonstrated as X̅. The difference between the reference and ADC measurement can be demonstrated as \tilde{X}. More specifically,

$${\overline{X}}_{k} = [ \begin{matrix}{i}_{L , ref} ( k ) \\ {v}_{c , ref} ( k ) \\ \end{matrix} ] , {\tilde{X}}_{k} = [ \begin{matrix}{i}_{L , ref} ( k ) - {i}_{L} ( k ) \\ {v}_{c , ref} ( k ) - {v}_{c} ( k ) \\ \end{matrix} ] . \qquad ( 31 )$$

Accordingly, a cost function can be demonstrated as

$$min {\sum }_{k = 0}^{{N}_{c}} {\tilde{X}}_{k}^{T} {Q}_{C} {\tilde{X}}_{k} + {\sum }_{k = 0}^{{N}_{P} - 1} △ {u}_{k}^{T} {R}_{C} △ {u}_{k} \qquad ( 32 )$$

where R_{c}, Q_{c} demonstrate the weighting factors for the input variables and state variables. The MPC process explained may be referred to as explicit MPC because the MPC algorithms, in this example, are generated offline as combinations of several piecewise affine functions based on a Multi-Parametric Toolbox (MPT). The methodology of the explicit MPC is to use the searching matrices, H_{s,c} and K_{s,c}, to find the active region, s. Then, within the active region, the calculation matrices, F_{s,c} and G_{s,c}, are leveraged to derive the optimal duty cycle according to the reference and state values. This explicit way contributes to reducing the computation burden for the micro-controller. In other examples, the MPC control may be implemented in a non-explicit manner.

For common mode voltage attenuation based on MPC control, the zero-sequence voltage v0*) is configured as half of DC bus voltage,

$${v}_{dc}^{*} ,$$

in the inverter function 515 and translated, along with v_{d}* and v_{q}*, from the dq0 reference frame to the abc reference frame for each elementary converter module 177b,177c. The tracking references,

$${v}_{c , a}^{*} , {v}_{c , b}^{*} and {v}_{c , c}^{*} ,$$

are composed of multi-phase sinusoidal and zero-sequence components to regulate the output capacitor voltage for active/reactive power and zero-sequence stabilization, respectively. Thus, the MPC controllers of the local control logic 178 (of each elementary converter module 177b, 177c) can follow the zero-sequence reference to maintain a constant common mode voltage and low leakage current.

### VFSS Control

As noted above, each of the elementary converter modules 177 may implement variable-frequency soft-switching (VFSS) control (e.g., to improve the efficiency by adjusting the switching frequency). For example, the local control logic 178 of each elementary converter module 177 may include a VFSS controller such as, for example, the VFSS controller 415 illustrated in FIG. 4. VFSS controller of each elementary converter module 177 may be configured for the derivation of a desired switching frequency (fs) according to the vertex and nadir points of phase leg side inductor current ripple and the soft switching operation criteria. The control block for each phase of the elementary module is demonstrated in FIG. 3 which is composed of VFSS controller, MPC controller and the hardware components. The desired switching frequency (fs) may be derived according to a threshold current, Iₜₕ, of soft switching operation criteria. The phase leg side inductor current ripple, Δi_{L}, can be demonstrated as

$$Δ {i}_{L} = \frac{d ( 1 - d ) {v}_{d c}}{{f}_{s} {L}_{f}} . \qquad ( 33 )$$

and the soft switching operation criteria require the vertex and nadir points of the phase leg side inductor current values to be larger than Iₜₕ and smaller than −Iₜₕ. Thus, the derivation of the time-varying switching frequency, fₛ, can be demonstrated as

$${f}_{s} = \frac{( 1 - d ) d {v}_{d c}}{2 ( {i}_{L , ave} + {I}_{t h} ) {L}_{f}} , {i}_{L , ave} \geq 0 \qquad ( 34 )$$

$${f}_{s} = \frac{( 1 - d ) d {v}_{d c}}{2 ( {I}_{t h} - {i}_{L , ave} ) {L}_{f}} , {i}_{L , ave} \leq 0 \qquad ( 35 )$$

in which i_{L,ave} represents the mean value of phase leg side inductor current.

Although the global control logic 180 has been described herein primarily as providing a reference voltage as the reference command to the local control logic 178 of each (active) elementary converter modules 177 such that the elementary converter modules 177 may serve as a voltage source with voltage-based control, in some examples, the global control logic provides a reference current as the reference command to the local control logic 178, such that the elementary converter block 177 may serve as a current source with current-based control.

### DC/DC and Replicated Power Stages

As noted with respect to the configuration 800, in some examples, one of the elementary converter modules 177 (e.g., module 177a) may boost a voltage level of the DC power from the battery 520 (e.g., from a first DC voltage level to a second DC voltage level that is higher than the first DC voltage level). For example, the module 177a may boost a 12V, 18V, 24V, 48V voltage of the battery 520 to 400V, 600V, or 800V. Accordingly, a battery 520 that outputs the first (lower) DC voltage can be used to drive an inverter (implemented by the elementary converter modules 177b-d) with the second (higher) DC voltage. In some examples, the battery 520 may output DC voltage at a sufficient level such that the DC voltage is not boosted by an elementary converter module 177 before inversion to drive the motor 825. One of the elementary converter modules 177 (e.g., module 177a) may also step down voltage from a second DC voltage level to a first DC voltage level that is lower than the second DC voltage level (e.g., to provide lower voltage to the battery 520 or other DC loads connected to the system 170). For example, the module 177a may step down a DC voltage received (e.g., from other elementary modules 177) from a higher voltage (e.g., 400V, 600V, or 800V) to a lower voltage (e.g., 12V, 18V, 24V, or 48V). With reference to block 310 of FIG. 3, the interconnection management logic 184 may determine (e.g., based on the operational data 186) whether to implement the elementary converter module 177a as a DC/DC boost converter or, for example, whether to inactivate the elementary converter module 177a and have the DC voltage output by the battery 524 directly drive the elementary converter modules 177b-177d implementing the inverter drive function. In some examples, one or more elementary modules 177 may be specifically configured (e.g., hardwired) as a DC/DC boost converter, and the interconnection management logic 184 or global control logic 180 may selectively enable and disable the DC/DC boost converter based on conditions of the system 170. For example, the global control logic 180 may turn off (disable) the DC/DC boost converter when a DC voltage level (e.g., output by the battery 520) is sufficient (e.g., determined by the global control logic 180 to be above a voltage threshold), and may turn on (enable) the DC/DC boost converter when the DC voltage level sags (e.g., determined by the global control logic 180 to be below the voltage threshold). In this way, conversion is disabled when the DC voltage is sufficient to reduce losses associated with conversion, thereby increasing the overall efficiency of the system 170.

In some examples, when sufficient elementary converter modules 177 are present, the interconnection management logic 184 may determine, based on the operational data 186, to replicate power stages to increase the power output by the elementary module layer 176. For example, the interconnection management logic 184 may configure a first set of three elementary converter modules 177 as a first stage three-phase inverter (e.g., similar to the elementary converter modules 177b-177d of FIG. 8) and configure a second set of three elementary converter modules 177 as a second stage three-phase inverter (e.g., again similar to the elementary converter modules 177b-177d of FIG. 8). The first and second stage of three-phase inverters may be driven synchronously such that two elementary converter modules 177 (one from each stage) provides output for each phase leg in a complementary (additive) manner, increasing the power output by the elementary module layer 176. Accordingly, when the operational data 186 indicates to the interconnection management logic 184 that a power output demand is above a certain threshold, and sufficient elementary converter modules 177 are present, the interconnection management logic 184 may implement such replicated power stages. In some examples, the interconnection management logic 184 further replicates power stages, such that, for example, the elementary module layer 176 includes a third stage three-phase inverter, a fourth stage three-phase inverter, and so on. However, when lower power requirements or other factors permit, the interconnection management logic 184 may disable replicated stages of elementary converter modules 177 (e.g., the second stage, third stage, and/or fourth stage, etc.) to allow for higher efficiency operation. For example, it may be more efficient to have two replicated power stages operating near full capacity or rated levels rather than four replicated power stages operating at half capacity or rated level.

In some examples, the interconnection management logic 184 may replicate other power stages of the power converter system 100 to increase available or actual power output as well. For example, the interconnection management logic 184 may replicate, for example, the AC/DC converters of the single-phase EV charging configuration 500, the AC/DC converters of the three-phase grid EV charging configuration 700, and/or the DC/DC converters of any of the configurations 500, 700, and 800. Additionally, the interconnection management logic 184 may implement replicated AC/DC or DC/AC power stages with or without one or more elementary converter modules 177 providing a DC/DC boost converter function.

### Transformer and Transformerless Converters

Although the power converter system 170, including the configurations 500, 700, and 800 of FIGS. 5A-B, 7, and 8, are described herein primarily with respect to non-isolated (transformerless) power converters as shown in FIG. 2B, in some examples, one or more of the elementary converter modules 177 of the system and configurations may be implemented as an isolated power converter that includes a transformer (see isolated power module of FIG. 2C). Thus, for example, with reference to FIGS. 5A-B, 7, and 8, one or more of the converter circuits 179 in the illustrated configurations may be implemented as an isolated converter circuit 280 as shown in FIG. 2C.

### Experimental Results

An example of the converter system 170, including elementary converter modules 177 implementing MPC-VFSS control, was experimentally tested with C3M0021120K MOSFETs (as switches M1, M2), with a TMS320F280049 control card (as control system 105), and configured with CAN communication (for the real time bus 190), as described herein. In this example, the MPC, sampling, and switching frequencies were 20 kHz, 80 kHz, and 80 kHz, respectively. In other examples, other control cards, switches, communication busses, switching frequencies, or control algorithms may be implemented.

In testing, the system 170 was reconfigured (e.g., according to the process 300 of FIG. 3) into configurations 500 (FIGS. 5A-B), 700 (FIG. 7), and 800 (FIG. 8).

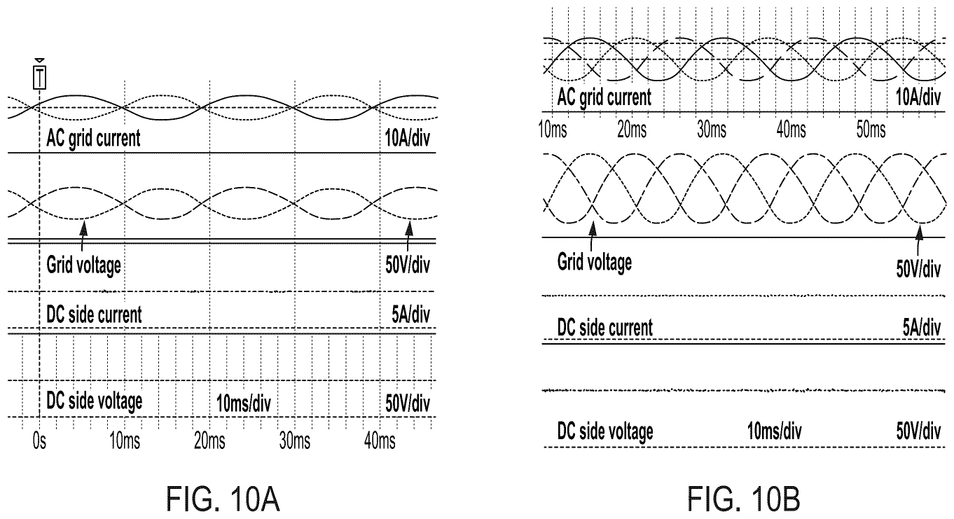

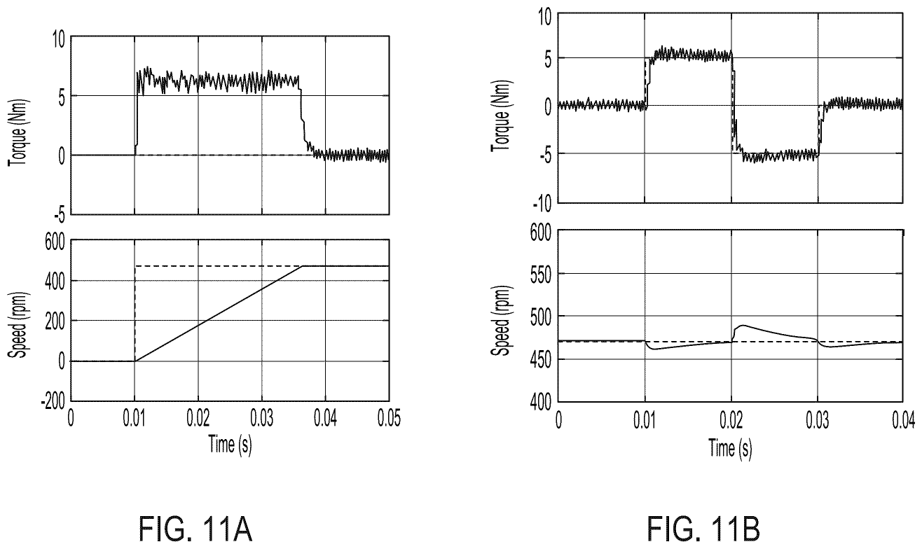

Testing results for the single- and three-phase EV charging configurations 500 and 700 are illustrated in FIGS. 10A and 10B, which illustrate the output grid side current, output capacitor voltage, DC side current and the corresponding DC voltage waveforms. The testing results of the traction motor configuration 800 are illustrated in FIGS. 11A and 11B, which illustrate a speed step of 430 rpm and torque step of −5 Nm to 5 Nm, respectively.

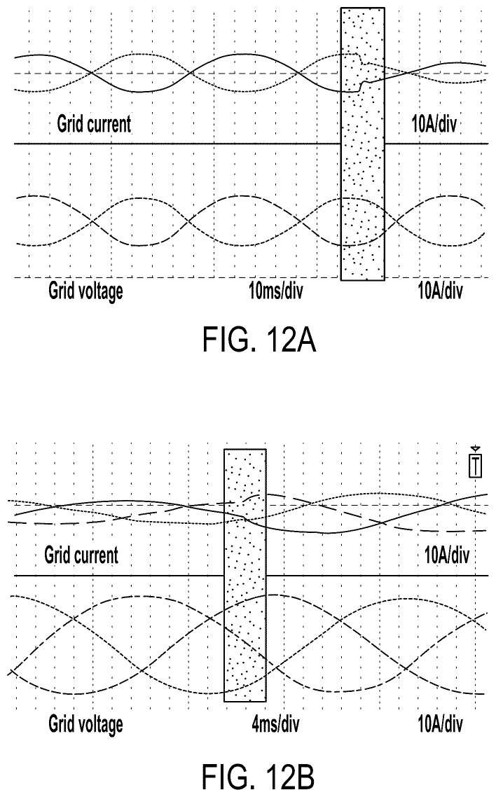

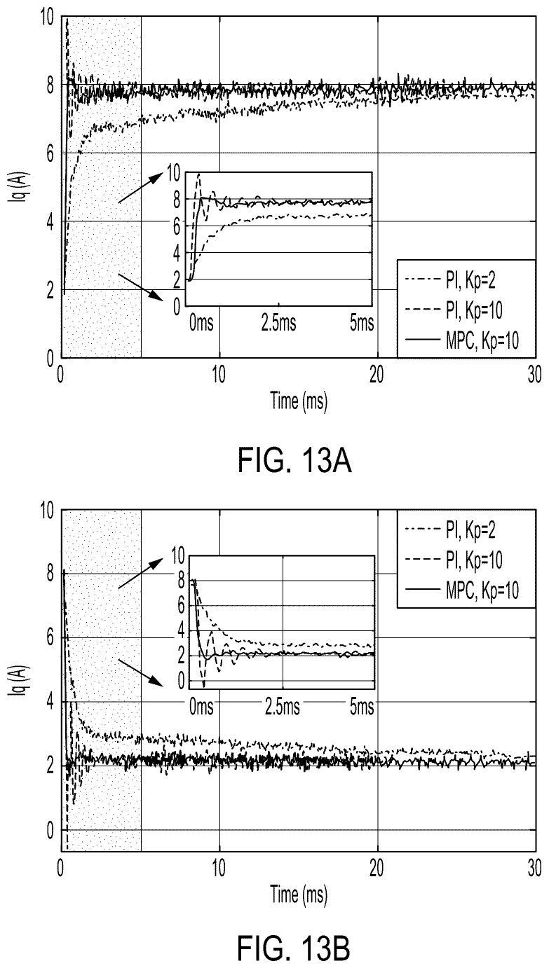

In testing, the local-level MPC control of the local control logic 178 of the elementary converter modules 177 was shown to improve the dynamic performance of the converter system 170 by actively damping the resonance of the LCL filter and enabling a high control bandwidth. By inserting an MPC loop between the high-level output current PI and PWM modulation (of the global control logic 180), the control gain is capable of being largely increased without inducing too much resonant oscillation. FIGS. 12A and 12B show, for the single- and three-phase EV charging configurations 500 and 700, the grid side current, output side capacitor voltage, inductor current and DC side voltage waveforms, respectively, with a current step between 2 A and 6 A. Also, for a better comparison with the conventional PI control, three testing cases of the captured sensor readings for grid current from 2 A to 8 A and 8 A to 2 A are shown in FIGS. 13A and 13B, respectively. Compared with low Ky of the conventional PI, the disclosed MPC control can track the reference five times faster without overshoot. Compared with high Ky of the traditional PI, the disclosed MPC control performs more steadily without oscillation.

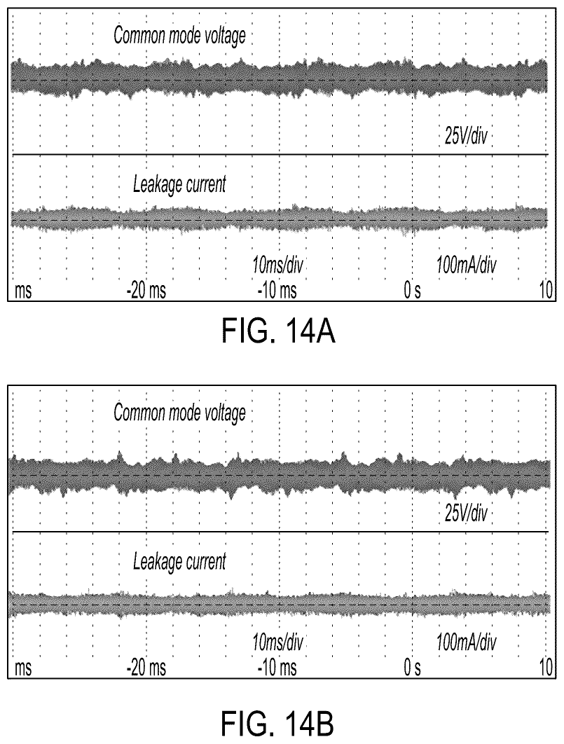

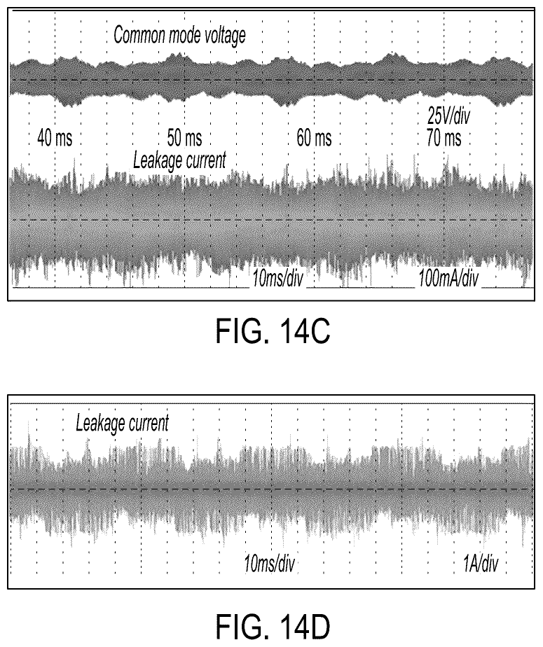

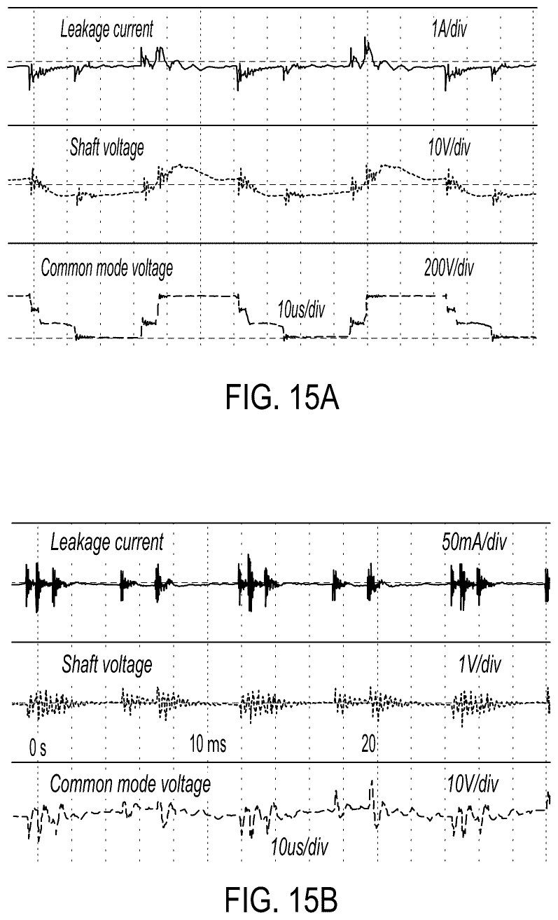

In the testing, the global control logic 180 of the application function layer 172 manages a zero-sequence voltage control to be distributed to the local MPC control of the local control logic 178 of the elementary converter modules 177. The zero-sequence control combined with topologies of the configurations 500, 700, and 800 of FIGS. 5A-B, 7, and 8, respectively, attenuate the leakage current and common mode voltage of the single and three-phase EV chargers of the configurations 500 and 700 and shaft voltage/bearing current of the motor 825 of the configuration 800. Thus, the non-isolated topology can save the cost of a bulky transformer that would otherwise be used to attenuate the leakage current and common mode voltage. The common mode voltage can be measured by capturing the fluctuation of the three-phase output capacitor voltages with the calculated mean values shown from a scope. The leakage current can be measured from the output side of the AC grid 525, 725 or motor 825 with a current probe. Specifically, FIGS. 14A-14D compare the common mode voltage and/or leakage current for the single-phase grid EV charging configuration 500 with zero-sequence control (FIG. 14A), the three-phase grid EV charging configuration 700 with zero-sequence controller (FIG. 14B), a grid-connected topology like configuration 500 but without zero-sequence control (FIG. 14C), and a conventional grid-connected topology without zero-sequence control (FIG. 14D), respectively. The topologies of configurations 500 and 700 can reduce 2-3 times leakage current relative to conventional topologies. However, combining the topologies of the configurations 500 and 700 with zero sequence control can reduce 8-12 times of the leakage current. Also, a comparison of leakage current, shaft voltage, and common mode voltage for a conventional motor connected topology (FIG. 15A) with the traction motor configuration 800 with zero sequence voltage control (FIG. 15B), demonstrates that the leakage current and shaft voltage on the motor 825 can be attenuated by 10-20 times. Dead time is a non-negligible factor that can induce extra variation on the common mode voltage. During turn-on/off transitions of the switching period, large dead time may result in more phase leg output voltage variations for each of the elementary converter modules 177. The voltage variations from all elementary converter modules 177 can generate a more unstable common mode voltage, which can be attenuated by the zero-sequence control.

In the testing of the system 170 with the proposed multi-layer architecture, control accuracy and robustness are provided by the cascaded control structure of the global control logic 180 in combination with the elementary converter modules 177. As shown in FIGS. 5A-B, 7, and 8 for the three configurations 500, 700, 800, the output side inductor current is directly managed by the (high level) global control logic 180 and the corresponding output side inductance can be free from the local MPC parametric modeling of the local control logic 178. Thus, the uncertainties of equivalent output parameters caused by the various interfaced grid 525, 725 or motor 825 may not influence the accuracy of the local MPC parametric modeling.

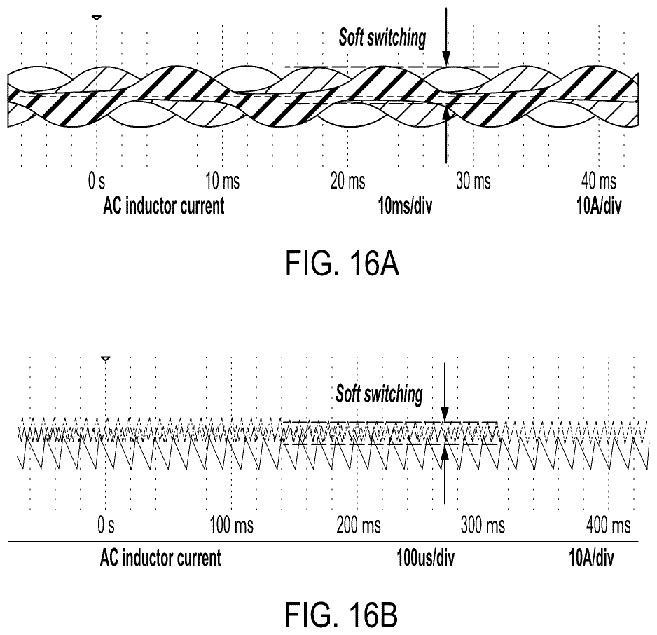

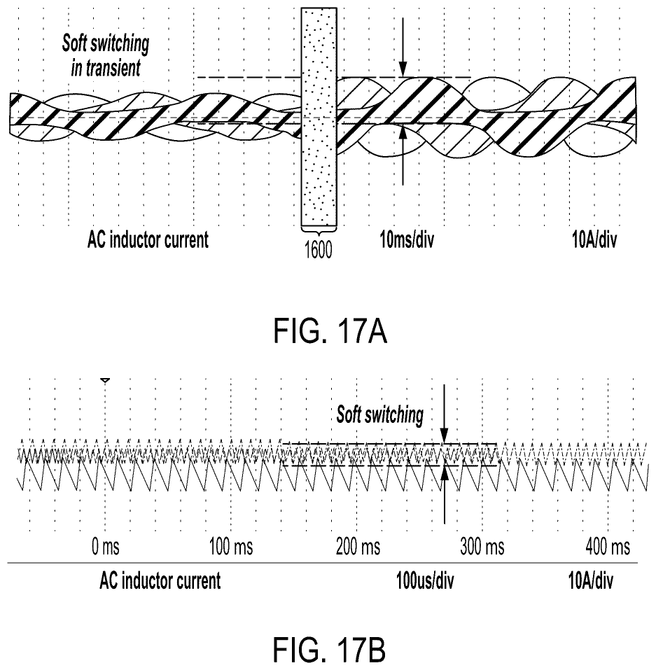

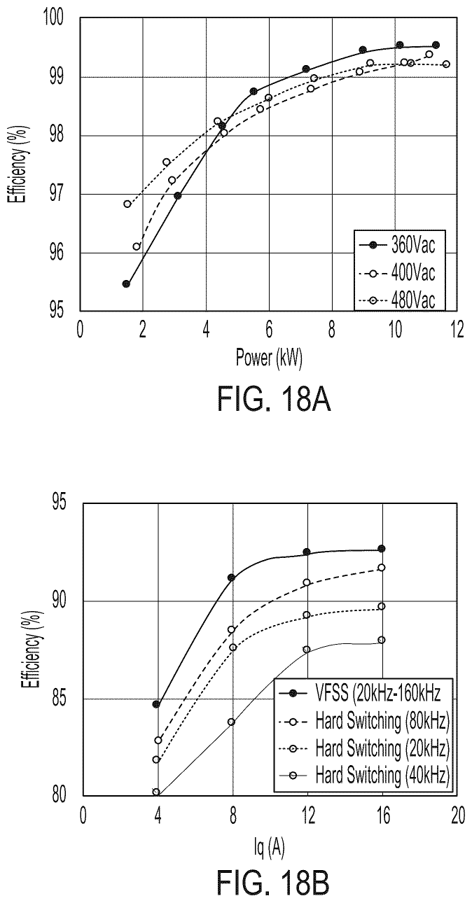

In the testing of the system 170, for the VFSS of the local control logic 178 of each of the elementary converter modules 177, the switching losses are reduced with an improved energy conversion efficiency. The experimental results of VFSS are shown in FIG. 16A-16B where the phase leg side inductor current waveforms achieve soft switching at full AC sinusoidal period. FIG. 16A shows AC side inductor current for EV charging with VFSS and MPC control, and FIG. 16B shows zoomed waveforms of FIG. 16A. Also, transient performance of VFSS is illustrated with AC side inductor current for EV charging (with VFSS and MPC control) in FIG. 17A-17B with a current step of 6 A, where FIG. 17B shows zoomed waveforms of FIG. 17A. The step transient is provided at area 1700 and, as shown, soft switching operation can still be maintained due to the better dynamic performance of MPC with less oscillation and high reference tracking speed. Also, efficiency curves of the EV chargers of configurations 500 and 700 and of the traction motor configuration 800 have been shown in FIG. 18A. The charger peak efficiency achieves more than 99% with different grid voltage levels. The motor traction efficiencies with and without VFSS under different switching frequencies are compared in FIG. 18B. The averaged efficiency of VFSS with the range of 20 kHz-160 kHz is 5%, 3% and 2% higher than the fixed frequencies of 80 kHz, 40 kHz and 20 kHz, respectively.

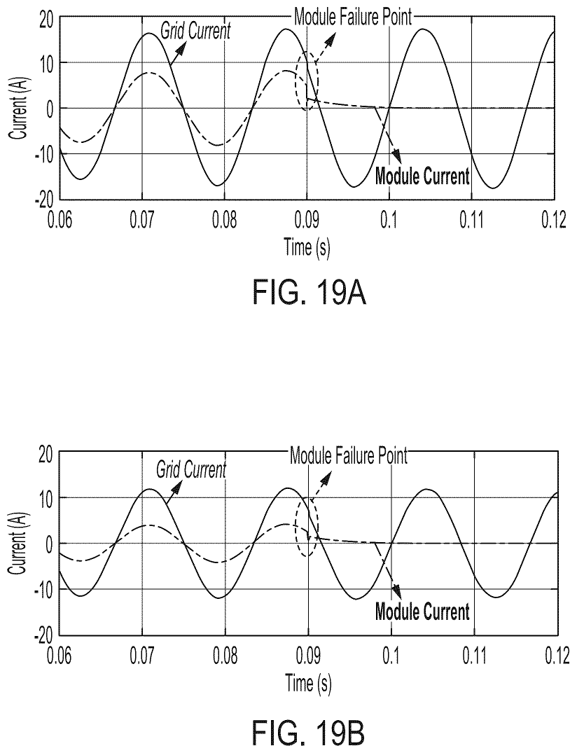

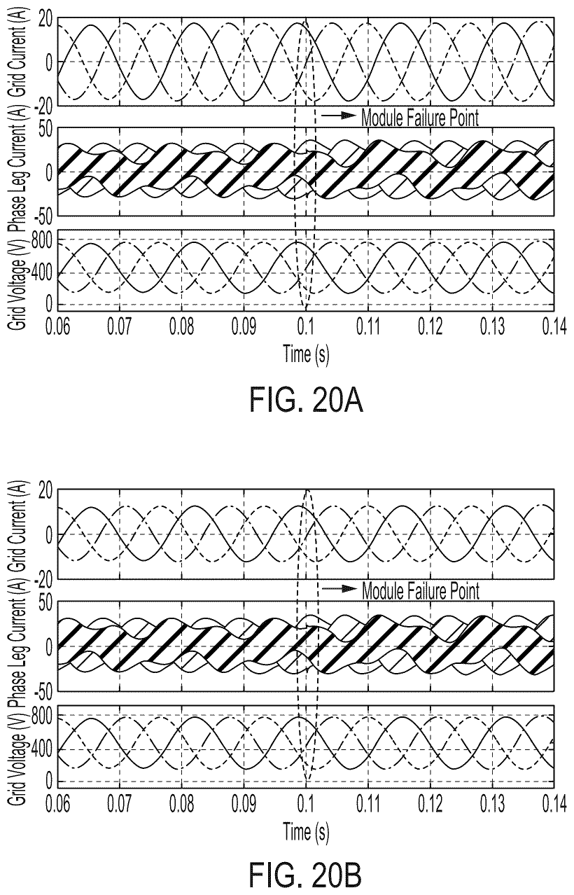

Further, the system 170 is capable of dealing with the fault scenarios. On one hand, for faults from the application function layer 172, because the high-level control algorithms of the global control logic 180 may be composed of relatively low complexity PI controllers and/or reference frame transformations without relatively high complexity online optimization, these control algorithms typically do not account for heavy computation burden or memory size. Thus, the control algorithms of the application function layer 172 can be configured in an electronic controller that is also implementing one or more of the local control logics 178 of the elementary converter modules 177, to be communicated with other elementary converter modules 177. Even if the high-level control function signals fail in one module, the local control logic 178 of another elementary converter module 177 may substitute in and serve to perform the high-level control functions of the global control logic 180. On the other hand, for a fault from the elementary module layer 176, the system 170 can configure redundant modules connected in each phase as backup elementary converter modules 177. If one of the elementary converter modules 177 fails, the backup module can be powered on or enabled as a substitute. In the event of a fault or failure of both the application function layer 172 and the elementary module layer 176, the system 170 may detect resulting over-current or over-voltage samplings and trip (disable). The validation of the fault management of the system 170 is illustrated in FIGS. 19A, 19B, 20A, and 20B. Two and three elementary converter modules 177 are connected in parallel for each phase to verify the fault management. Specifically, FIGS. 19A and 19B show a failed module output current and total grid current before and after the module failure with two and three elementary converter modules 177 in parallel, respectively. FIGS. 20A and 20B demonstrate the three-phase grid current, phase leg inductor current, and grid voltage before and after the module failure with two and three elementary converter modules 177 in parallel, respectively. Accordingly, even with failure of an elementary converter module 177, the converter system 170 can provide normal operation without power interruption.

The electronic controller(s) of the control system 105 are configured to facilitate, for example, the implementation of a power converter (e.g., by implementing the process 300 of FIG. 3). The memory(ies) of the control system 105 may thus include a computer program product that when executed on the electronic controller (which, as noted, may be a processor-based device) causes the processor-based device to perform operations to facilitate the implementation of procedures and operations described herein. The electronic controller may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the electronic controller. Other modules that may be included with the electronic controller may include a user interface to provide or receive input and output data. The electronic controller may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as, for example, magnetic media (such as, e.g., hard disks, floppy disks, etc.), optical media (such as, e.g., compact discs, digital video discs, Blu-ray discs, etc.), semiconductor media (such as, e.g., flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

### FURTHER EXAMPLES

Example 1: A method, apparatus, and/or non-transitory computer-readable medium storing processor-executable instructions for a non-isolated power converter system, comprising: a plurality of elementary power converter modules, each elementary power converter module including, respectively, power switching elements and an LC filter; and at least one electronic processor, the at least one electronic processor configured to: determine operational data for the power converter system; configure, based on the operational data, a power conversion function of the plurality of elementary power converter modules, the power conversion function defining one or more of the elementary power converter modules as active elementary power converter modules for implementing the power conversion function; determine electrical operating characteristics including an electrical operating characteristic for each of the one or more active elementary power converter modules; generate a control reference target, respectively, for each of the one or more active elementary power converter modules, each control reference target generated based on the electrical operating characteristics; and control the power switching elements, of each of the one or more active elementary power converter modules, based on the electrical operating characteristic and the control reference target for the active elementary power converter module.

Example 2: The method, apparatus, and/or non-transitory computer readable medium of Example 1, wherein the at least one electronic processor includes at least a plurality of local electronic processors, each local electronic processor: associated with a respective elementary power converter module of the plurality of elementary power converter modules; and configured to control the power switching elements of the elementary power converter module associated with the local electronic processor.

Example 3: The method, apparatus, and/or non-transitory computer readable medium of Example 2, wherein a first electronic processor of the local electronic processors or a global electronic processor is configured to: determine the electrical operating characteristics including the electrical operating characteristic for each of the one or more active elementary power converter modules; and generate the control reference targets for each of the one or more active elementary power converter modules.

Example 4: The method, apparatus, and/or non-transitory computer readable medium of any of Examples 2 to 3, wherein a first electronic processor of the local electronic processors or a global electronic processor is configured to: determine the operational data for the power converter system; configure, based on the operational data, the power conversion of the plurality of elementary power converter modules.

Example 5: The method, apparatus, and/or non-transitory computer readable medium of any of Examples 2 to 4, wherein each of the local electronic processors are coupled via a real-time communication bus.

Example 6: The method, apparatus, and/or non-transitory computer readable medium of any of Examples 1 to 5, wherein the at least one electronic processor includes local control logic for each of the plurality of elementary power converter modules, wherein, to control the power switching elements of each of the one or more active elementary power converter modules, each local control logic is configured to implement one or more of model predictive control and variable frequency soft switching, and wherein the plurality of elementary power converter modules and each local control logic are part of an elementary module layer of the multi-layer power converter system.

Example 7: The method, apparatus, and/or non-transitory computer readable medium of any of Examples 1 to 6, wherein the at least one electronic processor includes global control logic defining a plurality of converter control functions, the global control logic configured to: determine an active converter control function selected from the plurality of converter control functions, and generate the control reference target for each of the one or more active elementary power converter modules based on the electrical operating characteristics and the active converter control function; and wherein the global control logic is part of an application function layer of the multi-layer power converter system.

Example 8: The method, apparatus, and/or non-transitory computer readable medium of Example 7, wherein, to generate the control reference target for each of the one or more active elementary power converter modules, the global control logic transforms target values in a first reference frame to the control reference targets in a second reference frame, wherein the global logic implements zero sequence control by using a DC offset for a zero-sequence target value of the target values in the first reference frame.

Example 9: The method, apparatus, and/or non-transitory computer readable medium of any of Examples 1 to 8, wherein the at least one electronic processor includes interconnection management control logic, the interconnection management logic configured to: determine the operational data for the power converter system, the operational data indicative of a power conversion application type, a number of conversion stages for the power converter system, a converter topology for each of the conversion stages, and a number of the plurality of elementary power converter modules for each of the converter topologies; and configure, based on the operational data, the power conversion function of the plurality of elementary power converter modules.

Example 10: The method, apparatus, and/or non-transitory computer readable medium of Example 9, wherein, to configure the power conversion function of the plurality of elementary power converter modules, the interconnection management logic is further configured to: indicate, to global control logic of the at least one electronic processor, a converter control function from a plurality of converter control functions of the global control logic as an active converter control function, the global control logic further configured to generate the control reference target for each of the one or more active elementary power converter modules based on the active converter control function, and control interconnections of the plurality of elementary power converter modules to configure the elementary power converter modules according to the operational data.

Example 11: The method, apparatus, and/or non-transitory computer readable medium of any of Examples 1 to 10, wherein the LC filter of each of the plurality of elementary power converter modules includes: an upper capacitor coupled to a positive DC bus, a lower capacitor coupled to a negative DC bus, and an inductor coupled to the upper capacitor and to the lower capacitor at a filter node.

Example 12: The method, apparatus, and/or non-transitory computer readable medium of any of Examples 1 to 11, further comprising: a multi-layer architecture including: an elementary module layer including the plurality of elementary power converter modules and a local control logic associated with each elementary power converter module of the plurality of elementary power converter modules, each local control logic implemented by the at least one electronic processor and configured to control the power switching elements of the associated elementary power converter module; an interconnection management layer including interconnection management logic, implemented by the at least one electronic processor, to configure the power conversion function of the plurality of elementary power converter modules based on the operational data; and an application function layer including global control logic, implemented by the at least one electronic processor, to generate the control reference target for each of the one or more active elementary power converter modules.

Example 13: The method, apparatus, and/or non-transitory computer readable medium of any of Examples 1 to 12, wherein the multi-layer power converter system as a non-isolated multi-layer power converter system.

1. A multi-layer power converter system, the system comprising:
a plurality of elementary power converter modules, each elementary power converter module including, respectively, power switching elements and an LC filter; and
at least one electronic processor, the at least one electronic processor configured to:
determine operational data for the power converter system;
configure, based on the operational data, a power conversion function of the plurality of elementary power converter modules, the power conversion function defining one or more of the elementary power converter modules as active elementary power converter modules for implementing the power conversion function;
determine electrical operating characteristics including an electrical operating characteristic for each of the one or more active elementary power converter modules;
generate a control reference target, respectively, for each of the one or more active elementary power converter modules, each control reference target generated based on the electrical operating characteristics; and
control the power switching elements, of each of the one or more active elementary power converter modules, based on the electrical operating characteristic and the control reference target for the active elementary power converter module.

2. The multi-layer power converter system of claim 1, wherein the at least one electronic processor includes at least a plurality of local electronic processors, each local electronic processor:
associated with a respective elementary power converter module of the plurality of elementary power converter modules; and
configured to control the power switching elements of the elementary power converter module associated with the local electronic processor.

3. The multi-layer power converter system of claim 2, wherein a first electronic processor of the local electronic processors or a global electronic processor is configured to:
determine the electrical operating characteristics including the electrical operating characteristic for each of the one or more active elementary power converter modules; and
generate the control reference targets for each of the one or more active elementary power converter modules.

4. The multi-layer power converter system of claim 2, wherein a first electronic processor of the local electronic processors or a global electronic processor is configured to:
determine the operational data for the power converter system; and
configure, based on the operational data, the power conversion function of the plurality of elementary power converter modules.

5. The multi-layer power converter system of claim 2, wherein each of the local electronic processors are coupled via a real-time communication bus.

6. The multi-layer power converter system of claim 1,
wherein the at least one electronic processor includes local control logic for each of the plurality of elementary power converter modules,
wherein, to control the power switching elements of each of the one or more active elementary power converter modules, each local control logic is configured to implement one or more of model predictive control and variable frequency soft switching, and
wherein the plurality of elementary power converter modules and each local control logic are part of an elementary module layer of the multi-layer power converter system.

7. The multi-layer power converter system of claim 1,
wherein the at least one electronic processor includes global control logic defining a plurality of converter control functions, the global control logic configured to:
determine an active converter control function selected from the plurality of converter control functions, and
generate the control reference target for each of the one or more active elementary power converter modules based on the electrical operating characteristics and the active converter control function; and
wherein the global control logic is part of an application function layer of the multi-layer power converter system.

8. (canceled)

9. The multi-layer power converter system of claim 1,
wherein the at least one electronic processor includes interconnection management control logic, the interconnection management logic configured to:
determine the operational data for the power converter system, the operational data indicative of a power conversion application type, a number of conversion stages for the power converter system, a converter topology for each of the conversion stages, and a number of the plurality of elementary power converter modules for each of the converter topologies; and configure, based on the operational data, the power conversion function of the plurality of elementary power converter modules.

10. (canceled)

11. The multi-layer power converter system of claim 1, wherein the LC filter of each of the plurality of elementary power converter modules includes: an upper capacitor coupled to a positive DC bus, a lower capacitor coupled to a negative DC bus, and an inductor coupled to the upper capacitor and to the lower capacitor at a filter node.

12. The multi-layer power converter system of claim 1, further comprising:
a multi-layer architecture including:
an elementary module layer including the plurality of elementary power converter modules and a local control logic associated with each elementary power converter module of the plurality of elementary power converter modules, each local control logic implemented by the at least one electronic processor and configured to control the power switching elements of the associated elementary power converter module;
an interconnection management layer including interconnection management logic, implemented by the at least one electronic processor, to configure the power conversion function of the plurality of elementary power converter modules based on the operational data; and
an application function layer including global control logic, implemented by the at least one electronic processor, to generate the control reference target for each of the one or more active elementary power converter modules.

13. The multi-layer power converter system of claim 1, wherein the multi-layer power converter system as a non-isolated multi-layer power converter system.

14. A method of converting power, the method comprising:
determining, by at least one electronic processor, operational data for a power converter system including a plurality of elementary power converter modules, each elementary power converter module including, respectively, power switching elements and an LC filter;
configuring, by the at least one electronic processor based on the operational data, a power conversion function of the plurality of elementary power converter modules, the power conversion function defining one or more of the elementary power converter modules as active elementary power converter modules for implementing the power conversion function;
determining, by the at least one electronic processor, electrical operating characteristics including an electrical operating characteristic for each of the one or more active elementary power converter modules;
generating, by the at least one electronic processor, a control reference target, respectively, for each of the one or more active elementary power converter modules, each control reference target generated based on the electrical operating characteristics; and
controlling, by the at least one electronic processor, the power switching elements, of each of the one or more active elementary power converter modules, based on the electrical operating characteristic and the control reference target for the active elementary power converter module.

15. (canceled)

16. The method of claim 15, the method further comprising,
determining, by a first electronic processor of the local electronic processors or a global electronic processor, the electrical operating characteristics including the electrical operating characteristic for each of the one or more active elementary power converter modules; and
generating, by the first electronic processor, the control reference targets for each of the one or more active elementary power converter modules.

17. The method of claim 15, further comprising:
determining, by a first electronic processor of the local electronic processors or a global electronic processor, the operational data for the power converter system; and
configuring, by the first electronic processor, based on the operational data, the power conversion function of the plurality of elementary power converter modules.

18. (canceled)

19. The method of claim 14,
wherein the at least one electronic processor includes local control logic for each of the plurality of elementary power converter modules,
wherein controlling the power switching elements of each of the one or more active elementary power converter modules includes:
implementing, by each local control logic, one or more of model predictive control and variable frequency soft switching, and
wherein the plurality of elementary power converter modules and each local control logic are part of an elementary module layer of a multi-layer power converter system.

20. The method of claim 14, wherein the at least one electronic processor includes global control logic defining a plurality of converter control functions, the method further comprising:
determining, by the global control logic, an active converter control function selected from the plurality of converter control functions, and
generating the control reference target for each of the one or more active elementary power converter modules based on the electrical operating characteristics and the active converter control function; and
wherein the global control logic is part of an application function layer of a multi-layer power converter system.

21. The method of claim 20, wherein generating the control reference target for each of the one or more active elementary power converter modules includes:
transforming, by the global control logic, target values in a first reference frame to the control reference targets in a second reference frame, wherein the global logic implements zero sequence control by using a DC offset for a zero-sequence target value of the target values in the first reference frame.

22. The method of claim 14, wherein the at least one electronic processor includes interconnection management control logic, the method further comprising:
determining, by the interconnection management logic, the operational data for the power converter system, the operational data indicative of a power conversion application type, a number of conversion stages for the power converter system, a converter topology for each of the conversion stages, and a number of the plurality of elementary power converter modules for each of the converter topologies; and
configuring, by the interconnection management logic, based on the operational data, the power conversion function of the plurality of elementary power converter modules.

23. The method of claim 22, wherein configuring the power conversion function of the plurality of elementary power converter modules includes:
indicating, by the interconnection management logic, to global control logic of the at least one electronic processor, a converter control function from a plurality of converter control functions of the global control logic as an active converter control function, the global control logic further configured to generate the control reference target for each of the one or more active elementary power converter modules based on the active converter control function, and
controlling interconnections of the plurality of elementary power converter modules to configure the elementary power converter modules according to the operational data.

24. (canceled)

25. The method of claim 14, wherein the power converter system defines a multi-layer architecture including:
an elementary module layer including the plurality of elementary power converter modules and a local control logic associated with each elementary power converter module of the plurality of elementary power converter modules, each local control logic implemented by the at least one electronic processor, each local control logic controlling the power switching elements of the associated elementary power converter module;
an interconnection management layer including interconnection management logic, implemented by the at least one electronic processor, configuring the power conversion function of the plurality of elementary power converter modules based on the operational data; and
an application function layer including global control logic, implemented by the at least one electronic processor, generating the control reference target for each of the one or more active elementary power converter modules.

26. (canceled)

27. A non-transitory computer-readable medium storing computer-executable instructions, the instructions for causing at least one electronic processor:
determine operational data for a power converter system including a plurality of elementary power converter modules, each elementary power converter module including, respectively, power switching elements and an LC filter;
configure, based on the operational data, a power conversion function of the plurality of elementary power converter modules, the power conversion function defining one or more of the elementary power converter modules as active elementary power converter modules for implementing the power conversion function;
determine electrical operating characteristics including an electrical operating characteristic for each of the one or more active elementary power converter modules;
generate a control reference target, respectively, for each of the one or more active elementary power converter modules, each control reference target generated based on the electrical operating characteristics; and
control the power switching elements, of each of the one or more active elementary power converter modules, based on the electrical operating characteristic and the control reference target for the active elementary power converter module.

28. (canceled)

29. (canceled)

30. (canceled)

31. (canceled)

32. The non-transitory computer-readable medium of claim 27,
wherein the instructions further cause the at least one electronic processor to implement local control logic for each of the plurality of elementary power converter modules,
wherein, to control the power switching elements of each of the one or more active elementary power converter modules, each local control logic is configured to implement one or more of model predictive control and variable frequency soft switching, and
wherein the plurality of elementary power converter modules and each local control logic are part of an elementary module layer of a multi-layer power converter system.

33. The non-transitory computer-readable medium of claim 27,
wherein the instructions further cause the at least one electronic processor to implement global control logic defining a plurality of converter control functions, the global control logic configured to:
determine an active converter control function selected from the plurality of converter control functions, and
generate the control reference target for each of the one or more active elementary power converter modules based on the electrical operating characteristics and the active converter control function; and
wherein the global control logic is part of an application function layer of a multi-layer power converter system.

34. (canceled)

35. The non-transitory computer-readable medium of claim 27,
wherein the instructions further cause the at least one electronic processor to implement interconnection management control logic, the interconnection management logic configured to:
determine the operational data for the power converter system, the operational data indicative of a power conversion application type, a number of conversion stages for the power converter system, a converter topology for each of the conversion stages, and a number of the plurality of elementary power converter modules for each of the converter topologies; and
configure, based on the operational data, the power conversion function of the plurality of elementary power converter modules.

36. (canceled)

37. (canceled)

38. The non-transitory computer-readable medium of claim 27, wherein the power converter system defines a multi-layer architecture including:
an elementary module layer including the plurality of elementary power converter modules and a local control logic associated with each elementary power converter module of the plurality of elementary power converter modules, each local control logic implemented by the at least one electronic processor executing the instructions, each local control logic configured to control the power switching elements of the associated elementary power converter module;
an interconnection management layer including interconnection management logic, implemented by the at least one electronic processor executing the instructions, to configure the power conversion function of the plurality of elementary power converter modules based on the operational data; and
an application function layer including global control logic, implemented by the at least one electronic processor executing the instruction, to generate the control reference target for each of the one or more active elementary power converter modules.

39. (canceled)
